(19) United States
(12) Patent Application Publication
(10) Pub. No.: US 2026/0289510 A1
(43) Pub. Date: Sep. 24, 2026

(54) SYSTEM

(71) Applicant: SoftBank Group Corp., Tokyo (JP)

(72) Inventor: Tetsuya YOSHIMURA, Tokyo (JP)

(73) Assignee: SoftBank Group Corp., Tokyo (JP)

(21) Appl. No.: 19/567,408

(22) Filed: Mar. 16, 2026

(30) Foreign Application Priority Data
Mar. 19, 2025 (JP) 2025-045074

(51) Int. Cl. G06Q 10/1053; G06F 40/284; G06N 3/0475

(52) U.S. Cl. CPC G06Q 10/1053; G06F 40/284; G06N 3/0475

(57) ABSTRACT

A system includes a processor that is configured to receive input information from a user, analyze the input information to recognize an emotion of the user, generate a prompt sentence for instructing a generative AI model to perform a specific process based on a result of the emotion analysis, input the prompt sentence into the generative AI model to obtain optimal recruitment information, perform matching between the user and a recruiting department based on the obtained recruitment information, and notify the user of a result of the matching.

### CROSS-REFERENCE TO RELATED APPLICATION

This application is based on and claims priority under 35 USC 119 from Japanese Patent Application No. 2025-045074 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional internal job matching and recruitment support systems generally perform matching based on explicit conditions such as job type, department, skills, and work style conditions input by a user. However, such systems do not sufficiently take into account the emotional state of the user at the time of input, such as anxiety, motivation level, stress, or expectations regarding human relationships. As a result, there is a risk that the system provides recommendations or notifications that are technically appropriate but emotionally unsuitable, leading to a decrease in user satisfaction and engagement. In particular, when a user is anxious about a career change or internal transfer, uniform notification content and mechanical recommendations may cause psychological resistance, reduce the likelihood that the user will act on the recommendation, and ultimately diminish the effectiveness of the matching system. Furthermore, existing systems typically do not effectively utilize generative AI models in a manner that is dynamically controlled based on user emotions, and thus fail to generate tailored prompts or recruitment information that fully reflects the user's emotional state. Accordingly, there is a demand for a system that can recognize a user's emotion from input information, control a generative AI model based on the recognized emotion, obtain optimal recruitment information, and provide emotionally adaptive matching and notification to the user.

### SUMMARY

In order to solve the above-described problems, a system according to one aspect of the present invention comprises a processor configured to receive input information from a user, analyze the input information to recognize an emotion of the user, generate a prompt sentence for instructing a generative AI model to perform a specific process based on a result of the emotion analysis, input the prompt sentence into the generative AI model to obtain optimal recruitment information, perform matching between the user and a recruiting department based on the obtained recruitment information, and notify the user of a result of the matching. The processor may be further configured to notify the result of the matching in cooperation with an external communication application, whereby matching results can be delivered through communication channels such as email, messaging applications, or other external communication services used by the user. In addition, the processor may be configured to adjust notification content based on the emotion of the user, such that wording, level of detail, tone, and timing of the notification are dynamically adapted according to the recognized emotional state. Through these configurations, the system is capable of providing recruitment information and matching results that are both technically appropriate and emotionally suitable, thereby improving user satisfaction, reducing psychological barriers to internal career decisions, and enhancing the overall effectiveness of the recruitment and matching process.

The term “system” refers to an integrated combination of hardware and software components, including at least one processor and associated memory, storage, communication interfaces, and software modules, that collectively execute the processing described in the claims.

The term “processor” refers to any hardware component or combination of components capable of executing instructions, such as a central processing unit (CPU), graphics processing unit (GPU), microcontroller, digital signal processor, or a set of such units operating in cooperation, whether implemented on a single device or distributed across multiple devices.

The term “user” refers to a human individual who interacts with the system, provides input information to the system, and receives recruitment information, matching results, and notifications from the system.

The term “input information” refers to any data provided by the user to the system, including but not limited to text, selections, or other interaction data that express the user's preferences, conditions, questions, concerns, or other content from which the system can infer the user's intentions and emotional state.

The term “emotion of the user” refers to an emotional state associated with the user, such as anxiety, confidence, motivation, satisfaction, frustration, or other affective conditions, which is inferred by the system from the user's input information or related contextual data.

The term “emotion analysis” refers to a process in which the system analyzes the input information to recognize or infer the emotion of the user, for example by applying natural language processing, sentiment analysis, classification models, or other computational techniques.

The term “generative AI model” refers to a machine learning model, such as a large language model or other generative model, that is capable of generating text, recommendations, or other output content in response to prompts or inputs.

The term “prompt sentence” refers to a text or structured instruction generated by the processor and provided as input to the generative AI model, the content of which is designed to cause the generative AI model to perform a specific process, such as generating recruitment information or recommendations tailored to the user.

The term “specific process” refers to a particular operation or task performed by the generative AI model in response to the prompt sentence, including but not limited to generating or selecting recruitment information, recommending positions, or refining matching criteria based on the user's emotion and preferences.

The term “recruitment information” refers to information related to job openings, internal postings, or recruiting departments, including data such as job titles, required skills, work conditions, department names, locations, work styles, and other details used for matching the user with a recruiting department.

The term “optimal recruitment information” refers to recruitment information that has been selected, generated, or refined by the system as being most suitable for the user in view of the user's preferences, conditions, and recognized emotion.

The term “recruiting department” refers to an organizational unit, team, or department that is seeking to recruit personnel and for which recruitment information is available for matching with the user.

The term “matching” refers to a process in which the system evaluates compatibility between the user and one or more recruiting departments based on recruitment information, user preferences, and optionally the user's emotion, and selects at least one recruiting department as a recommended match.

The term “matching result” refers to information indicating the outcome of the matching process, including at least one recommended recruiting department and optionally associated job details, reasons for recommendation, and other related data.

The term “notify” refers to the act of causing the matching result or related information to be presented to the user via one or more communication channels, such as on-screen display, email, messaging applications, or other notification mechanisms.

The term “external communication application” refers to a communication or messaging service separate from the core system, such as an email service, chat application, or social messaging platform, with which the system interacts via an interface or API to deliver notifications to the user.

The term “notification content” refers to the information included in a notification sent to the user, such as the matching result, explanatory text, recommended actions, and any additional information that is presented to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

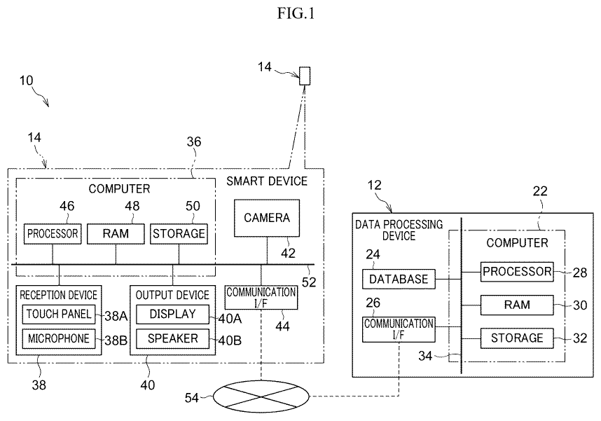

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

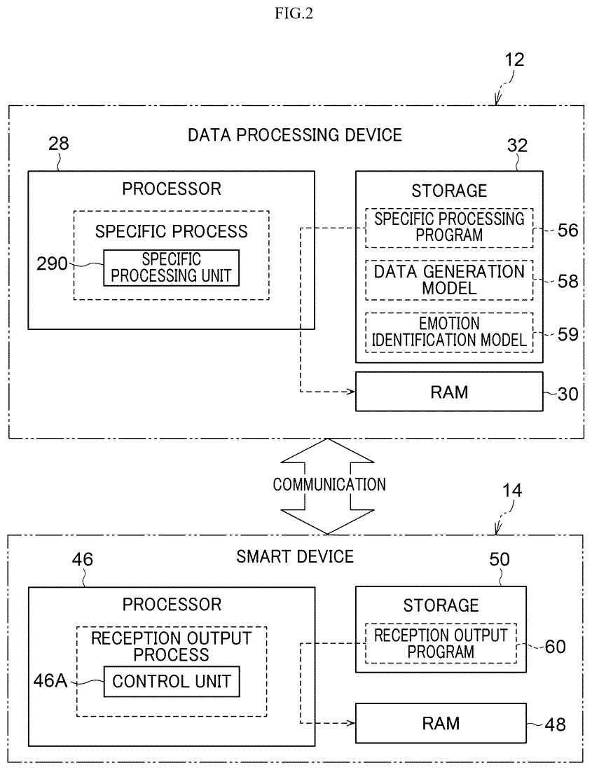

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented matching systems for recruitment largely rely on fixed rule sets or simple keyword-based retrieval executed by general-purpose processors. In such systems, a server typically receives user input describing desired working conditions and job contents, and then performs database lookups or static scoring logic. These approaches exhibit several technical problems. First, they handle user input as flat, unstructured text without converting it into structured data, which limits the ability of the processor to perform flexible, fine-grained data operations such as condition-wise comparison, constraint enforcement, or adaptive scoring. Second, the systems do not exploit the capabilities of modern generative AI models in a structured and controllable manner: any use of text generation tends to be superficial, and the processor is not configured to construct precise prompt sentences in a machine-oriented format that systematically encodes multiple job-related constraints. As a result, the server cannot stably obtain high-quality generated text suitable for deterministic post-processing and reliable matching.

Furthermore, conventional systems generally ignore the emotional state of the user at the technical processing level. Even when sentiment is informally considered, it is not integrated into the core computational pipeline of the server, such as prompt construction, model invocation, and result presentation. This leads to a further technical drawback: the human-computer interaction remains static and insensitive to user emotion, which degrades the effectiveness of communication over user interfaces and external communication applications, and can increase repeated accesses and corrections of input. Such inefficiencies cause unnecessary processing cycles, redundant network communication, and increased resource usage in the server and terminal devices.

In addition, typical systems that call generative AI models treat the model output as a final answer and do not perform systematic parsing and re-structuring of the generated text. Without parsing the generated text into machine-readable items and comparing them against structured user data, the processor cannot execute robust matching algorithms using numerical evaluation values. The absence of such post-processing prevents the system from using the generative AI model as a computational component in a larger, deterministic pipeline and results in unstable performance, inconsistent match quality, and difficulty in auditing system behavior.

Accordingly, there is a need for an improved computer-implemented system in which a processor is specifically configured to: (i) transform user input into structured data and emotion information, (ii) generate a controlled prompt sentence that encodes job-related constraints and emotional context, (iii) interact with a generative AI model as a functional component in a processing pipeline, (iv) parse and normalize the generated text into structured items suitable for algorithmic evaluation, and (v) compute and present matching results in a technically efficient and emotion-aware manner. Such a configuration can improve the functioning of the server itself by transforming unstructured text flows into structured, machine-operable data paths, reducing redundant communication, and providing more predictable and resource-efficient matching behavior.

The specific processing by the specific processing unit 290 of the data processing device 12 in Example 1 is realized by the following means.

The present invention provides a server comprising a processor configured to receive, from a terminal device, input information concerning working conditions and job contents provided by a user; analyze the input information to recognize an emotional state of the user and to convert the input information into structured data as attribute information; generate, on the basis of the structured data and the emotional state, a prompt sentence in natural language including at least one condition selected from a work category, a working style, a work location, an overtime work condition, and an experience period, and prepare the prompt sentence for input to a generative AI model; input the prompt sentence to the generative AI model and obtain, as generated text, recruitment information and explanatory information relating to candidate assignment departments; analyze the generated text to extract, for each candidate recruitment department, items including an affiliation category, a working system, a remote work condition, and an overtime work condition, and compare the extracted items with the structured data to calculate an evaluation value indicating a degree of matching for each candidate; determine a correspondence relationship between the user and a recruitment department on the basis of the evaluation value and convert a result of the determination into presentation information in a data format for presentation to the user; and transmit the presentation information to the terminal device via a communication line so that the user can view the presentation information on the terminal device, and optionally cooperate with an external communication application to transmit the presentation information and adjust an expression of the prompt sentence and an expression of the presentation information on the basis of the emotional state of the user. This enables the server to implement a technical processing pipeline in which unstructured user input is transformed into structured data and emotion information, a controlled prompt sentence is constructed for the generative AI model, the generated text is normalized into machine-readable items, and matching results are computed and presented in an emotion-aware manner, thereby improving the efficiency, reliability, and adaptability of computer-based recruitment matching and reducing unnecessary processing and communication overhead.

The term “terminal device” refers to an information processing apparatus operated by a user, including but not limited to a portable terminal, a stationary terminal, or any electronic device having an input interface, a display interface, and a communication interface, and configured to exchange data with a server via a communication network.

The term “input information” refers to data indicating at least working conditions and job contents, which is provided by a user through an input interface of a terminal device, and which may include text, selections from predefined options, numerical values, or other user-specified parameters relating to employment preferences.

The term “working conditions” refers to one or more constraints or preferences associated with employment, including but not limited to working hours, working style, place of work, remote work availability, overtime conditions, and compensation-related conditions, as expressed by a user.

The term “job contents” refers to information indicating desired or candidate roles, tasks, responsibilities, or functional areas within an organization, including but not limited to department types, job categories, and fields of specialization.

The term “emotional state” refers to a state of affect or sentiment of a user, which is inferred or recognized from input information or related data by a computational process, and which may include, for example, levels or categories of satisfaction, anxiety, enthusiasm, frustration, or other emotional attributes.

The term “structured data” refers to data obtained by converting unstructured or semi-structured input information into a format having explicit fields, attributes, or labels, such as key-value pairs, records, or objects, which can be systematically processed by a processor using logical operations, comparisons, or numerical calculations.

The term “attribute information” refers to one or more elements of structured data that represent properties, constraints, or characteristics related to working conditions, job contents, or user profile, such as work category, working style, work location, overtime work condition, and experience period.

The term “prompt sentence” refers to a sequence of natural language tokens constructed by a processor, which encodes at least one condition and contextual information in a form suitable for input to a generative AI model, and which is designed to cause the generative AI model to produce output relevant to recruitment or matching.

The term “generative AI model” refers to a trained computational model that receives a prompt sentence as input and generates text or other data as output based on probabilistic or neural network-based inference, and which is capable of producing natural language descriptions, recommendations, or explanations.

The term “generated text” refers to output data produced by a generative AI model in response to a prompt sentence, and including at least recruitment information, explanatory information, or other narrative content relating to candidate assignment departments or similar entities.

The term “recruitment information” refers to information indicating one or more potential employment opportunities, including but not limited to department identifiers, job titles, working systems, work locations, remote work conditions, overtime conditions, and other attributes relevant to hiring.

The term “candidate assignment department” refers to an organizational unit, team, or division that is identified as a potential destination for assigning or placing a user, based on recruitment information or matching processing.

The term “affiliation category” refers to a classification of a candidate assignment department within an organizational structure, including but not limited to higher-level divisions, business units, or functional groupings.

The term “working system” refers to a scheme or policy governing how working hours and schedules are arranged in a department, including but not limited to fixed working hours, flexible working hours, flextime systems, or shift systems.

The term “remote work condition” refers to a constraint or policy regarding whether and to what extent work can be performed away from a conventional workplace, including but not limited to permission, frequency, or limitations of remote work.

The term “overtime work condition” refers to a constraint or policy related to work performed beyond standard working hours, including but not limited to presence or absence of overtime, typical overtime hours, and restrictions on overtime.

The term “experience period” refers to a duration of time indicating a user's past engagement in work, roles, or fields relevant to a job, typically expressed as a number of months or years of experience.

The term “evaluation value” refers to a numerical or otherwise quantifiable indicator computed by a processor that represents a degree of matching between structured data relating to a user and attribute information extracted from generated text relating to a candidate assignment department.

The term “correspondence relationship” refers to a determined association between a user and at least one recruitment department or similar entity, which is based on evaluation values or other matching criteria, and which indicates that the user is suitable for or recommended for that entity.

The term “presentation information” refers to data representing at least one correspondence relationship and associated attributes in a format suitable for output to a user, including, for example, department names, working conditions, evaluation values, and explanatory text.

The term “communication line” refers to a physical or logical medium enabling data transfer between devices, including but not limited to wired networks, wireless networks, or any combination thereof, used for connectivity between a server and a terminal device or external systems.

The term “external communication application” refers to software executed on a terminal device, a server, or another computing apparatus, which is configured to send or receive messages or notifications via a communication network, including but not limited to electronic mail applications, messaging applications, or group communication platforms.

In one embodiment, a server implements the claimed system as a network-accessible recruitment matching platform. The server comprises at least one processor, a main memory, a non-volatile storage device, and a network interface. The server executes operating system software such as a general-purpose server operating system, web server software such as an HTTP server, and application server software such as a web application framework. The server further executes a trained generative AI model implemented, for example, as a transformer-based neural network deployed on a computation node equipped with a graphics processing unit.

A terminal is an information processing apparatus such as a smartphone, tablet, or personal computer. The terminal executes browser software or a dedicated application, and includes an input interface such as a touch panel or keyboard, a display interface such as a liquid crystal display panel or organic light-emitting display panel, and a communication interface such as a wireless communication module or wired communication adapter. A user operates the terminal to provide input information and to view matching results.

The server stores program modules in the non-volatile storage device and loads them into the main memory for execution by the processor. These program modules include at least a communication module, an input analysis module, an emotion recognition module, a data structuring module, a prompt generation module, a generative AI model interface module, a generated text analysis module, an evaluation module, a matching determination module, and a presentation control module. Each module performs concrete data processing and data computation on specific data structures as described below.

The server uses the communication module to receive, from the terminal, input information concerning working conditions and job contents provided by the user. The terminal converts the user's operations on the input interface into HTTP or HTTPS requests including textual fields such as desired department, working style, remote work preference, overtime tolerance, and years of experience. The server receives these requests via the network interface and stores the payload in the main memory.

The server uses the input analysis module to parse the payload as structured records. For example, the server uses a JSON parser or form-data parser to populate an internal data structure such as a record having fields “department”, “workStyle”, “remoteDaysPerWeek”, “overtimePreference”, and “experienceYears”. The server normalizes categorical values by mapping free-text expressions into internal codes; for example, the server maps “Sales” and “sales division” into a canonical code “DEPT_SALES” and maps “flextime system” into “WORKSTYLE_FLEX”. This normalization enables subsequent modules to operate on compact coded values rather than arbitrary text, thereby improving comparison speed and reducing memory usage.

The server uses the emotion recognition module to recognize an emotional state of the user. In one embodiment, the server applies a sentiment analysis model to the natural language portions of the input information. The sentiment analysis model is implemented as a neural network, for example, a bidirectional recurrent neural network, a convolutional neural network, or a transformer encoder that has been trained on labeled sentiment data. The server converts the text into token indices using a tokenizer, embeds the tokens into a vector space using an embedding matrix, and processes the sequence through layers of linear transformations, non-linear activation functions, and attention operations to obtain a sentiment vector. The server then classifies the sentiment vector into discrete categories such as “positive”, “neutral”, “negative”, or into more fine-grained emotional states such as “anxious”, “confident”, or “frustrated”. The server stores the recognized emotional state as an attribute in the structured data.

The server uses the data structuring module to convert the normalized field values and emotion information into structured data. For example, the server stores the data in a relational database table or an in-memory key-value structure. The structured data associates a unique user identifier with attributes such as department code, working style code, remote work requirement, overtime tolerance level, experience period, and emotional state. This data structuring allows the server to perform efficient indexed queries and comparisons, and to reuse historical preferences without re-parsing raw text.

The server uses the prompt generation module to generate a prompt sentence in natural language on the basis of the structured data and the emotional state. The server uses pattern templates and rule-based selection logic to assemble natural language segments corresponding to each attribute. For example, when the structured data indicates department code “DEPT_SALES”, working style code “WORKSTYLE_FLEX”, a minimum of two remote work days per week, and three years of relevant experience, the server generates a prompt sentence such as:

“Please recommend suitable departments in the sales division that use a flextime system and allow remote work at least two days per week. The candidate has 3 years of B2B corporate sales experience. List several options and explain briefly why each department is a good match.”

In another example, when the structured data indicates an engineering division, a flextime system with defined core hours, a minimum of three remote days, and four years of backend development experience, the server generates a prompt sentence such as:

“Suggest job roles and departments in the engineering division that have a flextime system with core hours from 11:00 to 15:00, allow remote work at least three days per week, and are suitable for a candidate with 4 years of backend development experience using Java and Spring. Provide the department name, typical responsibilities, and how the work environment matches these conditions.”

The server further adjusts the style and tone of the prompt sentence depending on the emotional state. For example, when the emotional state indicates “anxiety”, the server inserts phrases encouraging reassurance, such as “with a stable and supportive work environment”, and chooses more explicit explanatory requests, thereby causing the generative AI model to produce output that is more detailed and supportive. The server performs this adjustment by rule-based substitution and selection of alternative templates.

The server uses the generative AI model interface module to input the prompt sentence to a generative AI model. In one embodiment, the generative AI model is a transformer-based language model deployed on a computation node with a graphics processing unit. The server sends the prompt sentence over a network or local inter-process interface to the model-serving software, which may implement an inference engine that performs tokenization, embedding lookup, multi-head self-attention, feed-forward transformations, and softmax-based decoding. The model has been pre-trained on large-scale text corpora and fine-tuned on recruitment-related or organizational-structure-related data.

The generative AI model outputs generated text that includes recruitment information and explanatory information relating to candidate assignment departments. The server receives this generated text via the generative AI model interface module and stores it for further processing. Unlike conventional systems that present this generated text directly to the user, the server treats the generated text as intermediate data subject to deterministic post-processing.

The server uses the generated text analysis module to parse the generated text into structured items. In one embodiment, the server applies pattern matching and, optionally, a secondary lightweight parser model to segment the generated text into candidate department entries. Each entry may include a department name, a description of the working system, a description of remote work conditions, and a description of overtime work conditions. The server uses regular expressions and phrase-level heuristics to extract phrases such as “flextime with remote work up to 3 days per week” or “fully flexible schedule with remote work at least 2 days per week”. The server maps these phrases into internal codes and numeric ranges, such as a binary flag for flextime, an integer for maximum or minimum remote days, and a category for overtime level.

The server uses the evaluation module to compare these extracted attributes with the structured data derived from the user's input. The server implements a scoring algorithm that assigns an evaluation value to each candidate assignment department. For example, the server calculates a weighted sum in which matching the department type adds a given number of points, matching the working style adds another number of points, satisfying or exceeding the required number of remote days adds further points, and satisfying the overtime preference adds additional points. The server may normalize the evaluation value to a range such as 0 to 100. The server can additionally compute similarity measures between the user's experience profile and department descriptions by embedding both texts into a vector space and computing a cosine similarity, and then integrating this similarity into the evaluation value. This evaluation process uses arithmetic operations and vector operations that improve the precision and reproducibility of matching compared to human-only assessment.

The server uses the matching determination module to determine, on the basis of the evaluation values, a correspondence relationship between the user and recruitment departments. For example, the server selects the top N departments having the highest evaluation values or selects all departments whose evaluation values are above a specified threshold. The server then generates a structured representation of the correspondence relationship, associating each selected department with its evaluation value and key explanatory attributes. This representation is stored in memory or in a database as presentation information.

The server uses the presentation control module to convert the correspondence relationship into a data format suitable for transmission to the terminal. The server synthesizes human-readable sentences that explain the reasons for each match, such as: “Corporate Sales Department-Enterprise Clients: Flextime with remote work up to 3 days per week. This department matches your B2B corporate sales experience and your request for flextime and at least 2 remote days.”

The server encapsulates such sentences, along with the evaluation values and department identifiers, in a response structure and sends the response via the communication module to the terminal. When an external communication application is configured, the server also formats a notification message and transmits the message through the external communication application by calling its application programming interface.

The terminal receives the presentation information and displays it on the display interface. The user views the list of recommended departments and the corresponding explanations. The user may then refine the input conditions, such as adding a preference for low overtime, and the terminal sends the updated input information to the server. The server updates the structured data, generates a refined prompt sentence, invokes the generative AI model again, and repeats the analysis and matching procedure with the new constraints.

The server achieves technical improvements over conventional rule-based or purely keyword-based systems in several respects. Because the server converts user input and generative AI model output into structured data with explicit codes and numeric values, the server can perform high-speed comparisons and scoring using simple arithmetic operations and database indexing. This reduces processing time compared to repeated full-text scans and allows the system to scale to large numbers of departments and users. The use of a transformer-based generative AI model enables the server to capture complex relations between user requirements and job attributes, but, importantly, the server integrates the model as a component in a structured pipeline rather than relying on it as a black-box decision-maker. The server further improves accuracy and reduces error by applying deterministic post-processing to the generated text. By extracting specific attributes and verifying them against database records of actual departments, the server filters out model hallucinations and inconsistent descriptions, thereby improving the reliability of the presented matches. This technical arrangement leverages the generative AI model's ability to synthesize candidate options, while constraining the final output through structured validation and scoring. From a computational standpoint, the separation of prompt generation, neural inference, and structured post-processing results in a modular architecture that can be optimized independently. For example, the prompt generation module can be implemented as lightweight template logic that imposes a fixed pattern on prompts, which leads to more predictable generative AI model behavior and reduces the variance of outputs. This predictability allows the generated text analysis module to use simpler and faster parsing heuristics, thereby reducing computation time and memory usage compared to parsing arbitrary free-form text.

The emotion-aware aspects of the system also produce technical effects. By encoding the emotional state into the prompt sentence and into the presentation information generation, the server can reduce the number of repeated user interactions and corrective submissions. For example, if the emotional state indicates that the user is frustrated, the server can request more explicit, step-by-step explanations from the generative AI model and present more detailed reasons for each recommendation. This reduces user confusion and the need for re-queries, which in turn reduces network traffic and server load. The emotion recognition module thus becomes a functional input to the control flow and output formatting of the system, not merely a display embellishment.

In one embodiment, the generative AI model is trained using supervised fine-tuning and, optionally, reinforcement learning from human feedback. The server or an associated training environment uses a loss function such as cross-entropy between predicted token distributions and reference tokens during training, and updates model weights using a gradient-based optimization algorithm such as stochastic gradient descent or Adam. Training data may be augmented by paraphrasing job descriptions, synthesizing variations of working condition constraints, and introducing controlled noise in experience descriptions to increase robustness. During inference, the server sets decoding parameters such as temperature, top-k, or top-p to balance diversity and determinism. The server can configure these parameters differently depending on the type of prompt sentence, enabling further control over output structure.

Alternative embodiments are possible. For example, the generative AI model may be executed entirely on-premise by the server, using a local GPU, or may be accessed as a remote service over a network. The emotion recognition module may be integrated into the same neural network as the generative AI model or implemented as a separate classifier. The structured data may be stored in a relational database, a document database, or an in-memory key-value store. The evaluation module may use alternative scoring algorithms such as logistic regression or gradient-boosted decision trees trained on historical matching outcomes.

In another embodiment, the terminal executes a native application instead of a browser, and the server communicates with the terminal using a different application-layer protocol while maintaining the same overall data structures and processing flow. In yet another embodiment, the server uses multiple generative AI models with different sizes or specializations, selecting a smaller model for simple queries to reduce latency and a larger model for complex queries requiring more detailed analysis. The server may also batch multiple users'prompt sentences into a single inference call to the generative AI model to improve throughput and computational efficiency.

By organizing data into explicit fields, by using a transformer-based generative AI model under constrained prompt patterns, by systematically parsing and validating the generated text, and by incorporating emotion-aware formatting and interaction control, the server improves the functioning of the computer itself. The system reduces network load by decreasing repeated queries, reduces CPU and GPU time through structured prompting and post-processing, and enhances matching precision through algorithmic evaluation values, thereby providing technical effects beyond mere automation of human judgment.

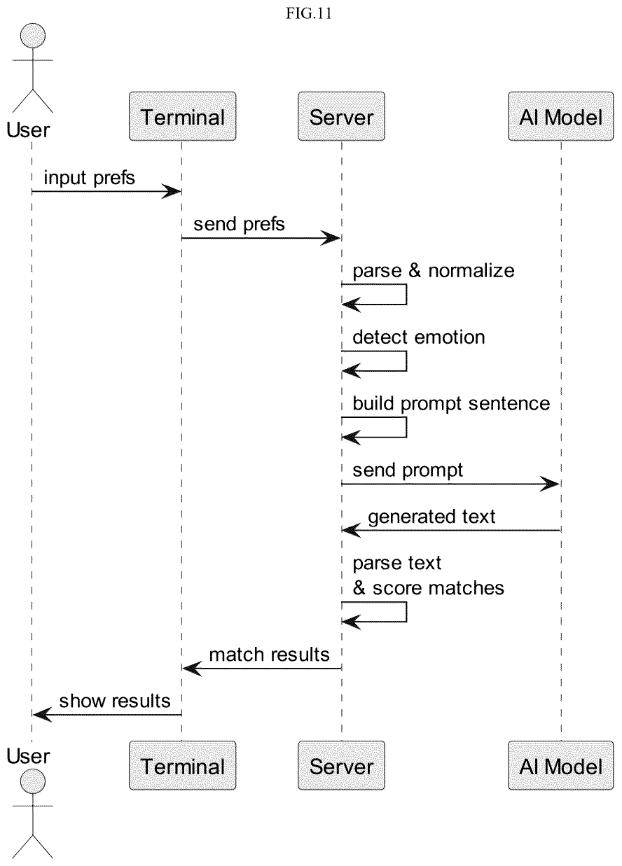

The following describes the processing flow using FIG. 11.

### Step 1:

The user operates the terminal to launch a browser or native application and opens a screen for specifying working conditions and job contents.
The terminal renders input fields such as desired division, working style, remote work requirement, overtime tolerance, and experience period.
Input: User operations (keyboard input, touch input) specifying textual or selected values for each field.
Output: Internal form data on the terminal, for example a key-value structure such as {department, workStyle, remoteDaysPerWeek, overtimePreference, experienceYears}. The terminal converts individual keystrokes and selections into this form data by binding UI components to corresponding variables.

### Step 2:

The terminal validates the input information and transmits it to the server.
The terminal checks that required fields are not empty and that numeric fields such as remoteDaysPerWeek and experienceYears contain parsable numbers.
Input: Form data compiled on the terminal.
Output: An HTTP or HTTPS request message (for example, POST) containing a serialized representation (for example, JSON) of the input information.
The terminal uses a communication library or browser networking stack to serialize the form data and send it through the communication interface to the server.

### Step 3:

The server receives the request message and parses the raw input information.
The server uses a web framework or request-handling library to read the request body and parse the serialized data structure.
Input: HTTP or HTTPS request containing a JSON payload or similar serialized data.
Output: An internal data object on the server, for example {department: “Sales”, workStyle: “Flextime”, remoteDaysPerWeek: 2, overtimePreference: “Low”, experienceYears: 3}. The server performs data parsing by mapping the serialized representation to in-memory structures, checking data types, and discarding malformed fields.

### Step 4:

The server normalizes the parsed input information into canonical codes and formats.
The server consults predefined mapping tables or configuration records to convert free-text values into standardized internal codes.
Input: Parsed data object with user-provided strings and numbers.
Output: Normalized structured data, for example {departmentCode: “DEPT_SALES”, workStyleCode: “WORKSTYLE_FLEX”, remoteDaysPerWeek: 2,overtimePreferenceLevel: “OT_LOW”, experienceMonths: 36}.
The server performs data conversion operations such as string-to-code lookups, unit conversions (years to months), and range classification (for example, mapping “few hours of overtime” to an overtime level category).

### Step 5:

The server recognizes an emotional state of the user from at least part of the input information.
The server extracts free-text comments or preference descriptions and passes them to an emotion recognition module that implements a neural network model.
Input: Textual segments from the user input, such as comments on current job dissatisfaction or expectations.
Output: An emotional state classification, for example “anxious”, “neutral”, or “confident”, together with an associated probability or score.
The server performs tokenization of the text, transforms tokens into numeric embeddings, applies layers of linear transformations and non-linear activation functions in the neural network, and computes a classification vector. The server selects the emotional state corresponding to the highest probability in the classification vector.

### Step 6:

The server combines the normalized structured data and the emotional state into a unified user profile record.
The server builds a record that includes all attribute codes, numeric values, and the emotional classification.
Input: Normalized structured data and the emotional state classification.
Output: A user profile record such as {userId, departmentCode, workStyleCode, remoteDaysPerWeek, overtimePreferenceLevel, experienceMonths, emotionalState}.
The server performs association and storage operations, optionally inserting or updating a record in a database so that the profile can be referenced in later processing steps.

### Step 7:

The server generates a prompt sentence in natural language based on the unified user profile.
The server selects text fragments from a set of templates according to the department code, working style code, remote work requirement, overtime preference, experience period, and emotional state.
Input: User profile record containing attribute codes and emotionalState.
Output: A prompt sentence such as “Please recommend suitable departments in the sales division that use a flextime system and allow remote work at least two days per week. The candidate has 3 years of B2B corporate sales experience. List several options and explain briefly why each department is a good match.”
The server uses conditional rules to concatenate relevant text fragments and may insert emotional modifiers, such as requesting more detailed explanations when emotionalState is “anxious”. This involves string operations, template variable replacement, and conditional selection of alternative sentence forms.

### Step 8:

The server prepares a generative AI model request with the prompt sentence.
The server constructs a request payload that includes the prompt sentence and inference parameters such as maximum token length and decoding temperature.
Input: Prompt sentence text.
Output: A structured inference request object, for example {modelName, promptSentence, maxTokens, temperature}.
The server converts the prompt sentence into the request format required by the generative AI model-serving interface, ensuring compatible encoding and parameter ranges.

### Step 9:

The server transmits the prompt sentence to the generative AI model and triggers inference.
The server sends the inference request object to a model-serving component, either locally or over a network connection.
Input: Model request object containing the prompt sentence and inference parameters.
Output: An inference response containing generated text from the generative AI model.

The generative AI model internally performs tokenization of the prompt sentence, computes hidden states through multiple layers of attention and feed-forward networks, and outputs a sequence of tokens representing the generated text. The server receives this output as part of the response.

### Step 10:

The server extracts and stores the generated text returned by the generative AI model.
The server parses the response format to isolate the main generated text sequence.
Input: Inference response including generated text and metadata such as token counts or log probabilities.
Output: A plain-text string representing recruitment recommendations and explanations.
The server performs data extraction and removes model-specific metadata, storing only the relevant natural language output in memory for further analysis.

### Step 11:

The server analyzes the generated text to identify candidate assignment departments and their attributes.
The server segments the generated text into logical units such as list items or paragraphs, then applies pattern matching and parsing rules to each unit.
Input: Plain-text generated output including descriptions like “Corporate Sales Department Enterprise Clients: flextime with remote work up to 3 days per week.”
Output: A collection of candidate department entries, each with extracted attributes such as {departmentName, workingSystemDescription, remoteWorkDescription, overtimeDescription}.
The server performs operations including string splitting on delimiters, regular expression matching for phrases related to flextime and remote work, and mapping of recognized phrases into normalized attribute values.

### Step 12:

The server converts the extracted textual attributes into internal codes and numeric values.
The server uses the same or similar normalization logic as in earlier steps to ensure consistency.
Input: Candidate department entries with textual descriptions of working system, remote work, and overtime conditions.
Output: Normalized candidate records such as {departmentName, workStyleCode, remoteDaysRange, overtimeLevelCategory}.
The server performs string-to-code lookups, pattern-based detection of numeric ranges (for example, “up to 3 days” mapped to remoteDaysRange=[0,3]), and classification of overtime descriptions into predefined categories.

### Step 13:

The server computes evaluation values expressing a degree of matching between the user profile and each candidate department.
The server applies a scoring function that processes both the user profile record and each normalized candidate record.
Input: User profile record and list of normalized candidate department records.
Output: A list of evaluation values, each associated with a candidate department, for example {departmentName, matchScore}.
The server performs arithmetic operations such as weighted sums, where exact matches in department type add a particular weight, satisfaction of minimum remoteDaysPerWeek adds another weight, alignment with overtimePreferenceLevel adds additional weight, and similarity between user experience and job description contributes a similarity score. The server may compute text similarity by embedding user experience and department description into vectors and calculating cosine similarity, then blending this value into the matchScore.

### Step 14:

The server determines a correspondence relationship between the user and one or more recruitment departments based on the evaluation values.
The server sorts candidate departments by matchScore and selects those exceeding a threshold or the top N departments.
Input: List of candidate departments with matchScore values.
Output: A structured representation of final matches, such as {userId, matchedDepartments: [{departmentName, matchScore, attributes},]}.
The server executes sorting algorithms on the list, filters entries according to threshold conditions, and composes a final match list that represents the correspondence relationship.

### Step 15:

The server generates presentation information for the user that explains the selected matches.
The server synthesizes explanatory sentences using department attributes and matchScore values.
Input: Structured match list containing department identifiers, attribute codes, and evaluation values.
Output: Presentation information containing human-readable explanations, such as “Corporate Sales Department Enterprise Clients: Flextime with remote work up to 3 days per week. This department matches your request for flextime, remote work at least 2 days per week, and low overtime.”
The server performs template-based sentence generation, converting codes back into descriptive phrases and embedding evaluation values into explanation templates.

### Step 16:

The server transmits the presentation information to the terminal.
The server packages the presentation information into a response payload and sends it through the communication interface over a network.
Input: Presentation information structure ready for output.
Output: An HTTP or HTTPS response message containing presentation information for rendering.
The server sets response headers and serializes the structured content so that the terminal can parse it and display it to the user.

### Step 17:

The terminal receives the response and renders the recommendations on its display.
The terminal parses the response payload and maps the presentation information into visual user interface elements.
Input: HTTP or HTTPS response message containing presentation information.
Output: A graphical display showing department names, working conditions, match scores, and explanations.
The terminal executes UI rendering operations such as creating list items, setting text labels, and arranging components on the screen so that the user can review and select from among the recommended departments.

### Step 18:

The user optionally refines the preferences or selects a department based on the displayed information.
The user performs operations such as adding conditions (for example, “almost no overtime”) or pressing a selection button for a specific department.
Input: On-screen information and user actions on the terminal's input interface.
Output: Updated form data or selection commands transmitted to the server in a subsequent request.
The terminal again collects the user's new inputs or selection signals, updates its internal form data, and sends another request to the server, which restarts processing from earlier steps with the refined conditions.

### Step 19:

The server optionally cooperates with an external communication application to send notifications about the matching result.
The server formats a concise summary message based on the final matches and invokes an external communication interface.
Input: Final match list and user contact identifiers associated with external communication services.
Output: Notification messages sent through external communication channels, such as messaging platforms or email.
The server composes text such as “Two departments match your conditions: Corporate Sales Department Enterprise Clients; Inside Sales Team Mid-Market. Please check your portal for details.” and calls the external application's programming interface to deliver this message, thereby extending the presentation information beyond the terminal and reducing the need for repeated manual status checks.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems typically rely on static rule sets, simple keyword matching, or pre-trained fixed models to select items in response to user input. Such systems often treat user conditions as direct query parameters to a database and simply return items satisfying exact matches or predefined similarity thresholds. As a result, these systems frequently fail to capture nuanced user requirements expressed in natural language, and they are not able to flexibly generate or adapt recommendation logic at run time. Furthermore, many existing architectures treat interaction with generative AI models, if used at all, as an unstructured text-in/text-out process that is loosely coupled to the surrounding application logic. This leads to several technical shortcomings in terms of data handling, processing efficiency, and system adaptability.

For example, in conventional systems, the generation of input sentences to a generative AI model (prompt sentences) is often implemented as ad hoc concatenation of strings in application code, without explicit modeling of user requirement attributes or systematic reuse of past interactions. This leads to inconsistent prompts, unstable model outputs, and difficulty in maintaining or improving the system over time. Additionally, existing systems usually accept the text output of a generative AI model as-is, and rely on manual inspection or simplistic parsing, thereby failing to convert the output into structured data suitable for further automated filtering, ranking, and logging. Consequently, such systems cannot reliably integrate the model's output with database records, cannot efficiently perform refinement of candidate items, and cannot use historical interactions to improve future prompt design and ranking logic.

Moreover, conventional notification mechanisms in recommendation systems are typically separate from the core recommendation engine, and are not designed to dynamically adjust content and level of detail of notifications based on structured historical interaction data with a generative AI model. As a result, the system cannot effectively control what information is surfaced to external communication applications in real time, leading to either oversimplified or overly verbose notifications that do not reflect the user's evolving requirements or the system's accumulated experience.

From the perspective of computer technology, there is a need for a system architecture and processing method that (i) formally extracts requirement attributes from user input, (ii) generates prompt sentences for a generative AI model in a structured and adaptive manner, (iii) converts generated text into structured item candidate data, (iv) performs automated filtering and ranking based on requirement attributes, and (v) records and reuses interaction history to improve both prompt templates and ranking criteria. Such a system would provide a technical improvement over conventional recommendation architectures by tightly integrating generative AI model interaction with deterministic data processing pipelines in the processor, thereby enhancing the accuracy, consistency, and maintainability of item recommendation processing while improving the efficiency of data handling and notification control.

The specific processing by the specific processing unit 290 of the data processing device 12 in Application Example 1 is realized by the following means.

The present invention provides a server comprising a processor configured to receive input information from a user including conditions related to an item; analyze the input information to extract requirement attributes of the user as structured data; search an information storage device storing item information corresponding to the requirement attributes; generate a prompt sentence for generation by formatting, as natural-language description information, the requirement attributes based at least in part on a search result; input the prompt sentence for generation into a generative AI model; obtain, by text generation processing of the generative AI model, a plurality of item candidate information that conforms to the requirement attributes; analyze text of the item candidate information and convert the text into structured data including at least an item name, an item description, price information, and a suitability reason; filter and rank the item candidate information based on a degree of conformity to the requirement attributes to specify recommended item information to be presented to the user; convert the recommended item information into a display data format and transmit the display data format to a user terminal to cause the user terminal to visually present the recommended item information; and record the prompt sentence for generation, response text from the generative AI model, and the recommended item information as history information, and update a template of the prompt sentence for generation or conditions of the ranking based on the history information. This enables an improved computer-implemented recommendation process in which interaction with the generative AI model is structurally integrated into the data processing pipeline, allowing the processor to generate consistent and optimized prompt sentences, convert unstructured model output into structured candidate data, iteratively refine filtering and ranking based on recorded history, and thereby enhance the accuracy, adaptability, and computational efficiency of item recommendation and notification control relative to conventional systems.

The term “processor” refers to a hardware-based information processing unit, such as a central processing unit or a computing device including one or more processing cores, that executes instructions to perform the functions described in the claims.

The term “user” refers to an operator or entity that provides input information to the system and receives recommended item information from the system.

The term “input information” refers to data supplied by the user to the system, including at least conditions, preferences, or constraints related to an item to be recommended.

The term “requirement attributes” refers to structured data elements representing the user's requirements, extracted from the input information, such as desired category, material, style, price range, or other item-related characteristics.

The term “information storage device” refers to a hardware or software-based storage resource, such as a database system or memory device, that stores item information and history information used by the processor.

The term “item information” refers to data records stored in the information storage device that describe individual items, including attributes such as name, category, material, description, price, and availability.

The term “prompt sentence for generation” refers to a natural-language text string constructed by the processor, based on the requirement attributes and optionally a search result, for use as input to a generative AI model to cause the model to generate item candidate information. The term “generative AI model” refers to a machine-learned information processing model capable of generating text output in response to text input, based on internal parameters obtained through training on data, and performing text generation processing such as natural language completion or suggestion.

The term “text generation processing” refers to a computational process executed by the generative AI model in which input text, including the prompt sentence for generation, is transformed into output text, such as item candidate descriptions, by applying learned parameters and inference algorithms.

The term “item candidate information” refers to information corresponding to potential recommended items, generated as text by the generative AI model in response to the prompt sentence for generation.

The term “structured data” refers to data organized into predefined fields, such as an item name, item description, price information, and suitability reason, which can be programmatically processed, filtered, and ranked by the processor.

The term “item name” refers to a textual identifier or title that distinguishes one item from another within the item information or item candidate information.

The term “item description” refers to explanatory text describing characteristics, features, or intended use of the item.

The term “price information” refers to data indicating a monetary amount or price range associated with an item, expressed in one or more currencies.

The term “suitability reason” refers to explanatory text or data indicating why a particular item candidate is considered to conform to or match the requirement attributes.

The term “degree of conformity” refers to a measure, score, or evaluation criterion indicating how well a given item candidate satisfies the requirement attributes extracted from the input information.

The term “recommended item information” refers to one or more selected item candidate records, after filtering and ranking based on the degree of conformity, that are determined by the processor to be appropriate for presentation to the user.

The term “display data format” refers to a representation of the recommended item information, such as structured text, markup, or other formatting suitable for visual presentation on a user terminal. The term “user terminal” refers to a computing device used by the user, such as a smartphone, tablet, or personal computer, that is capable of communicating with the server, receiving the display data format, and visually presenting the recommended item information. The term “history information” refers to data recorded over time by the processor, including at least prompt sentences for generation, response text from the generative AI model, recommended item information, and optionally associated user actions or feedback. The term “template of the prompt sentence for generation” refers to a configurable pattern or format definition used by the processor to construct a prompt sentence for generation from requirement attributes and other data, the template including fixed text portions and variable portions to be filled with structured data. The term “conditions of the ranking” refers to parameters, rules, or algorithms used by the processor to determine the order or priority of item candidate information based on the degree of conformity or other evaluation criteria. The term “notification message” refers to data generated by the processor that includes at least a summary content of the recommended item information and identification information enabling reference to the recommended item information, the data being intended for delivery to the user via an external communication application. The term “summary content” refers to a condensed representation of the recommended item information, such as a short text description or list highlighting key attributes of one or more recommended items.

The term “identification information” refers to data, such as a uniform resource locator, identifier, or token, that enables a recipient system or user to access detailed recommended item information.

The term “external communication application” refers to a software or service separate from the core recommendation system, such as a messaging service, email service, or notification platform, that is capable of transmitting the notification message to the user.

The term “writing style” refers to characteristics of the notification message text, including tone, formality, vocabulary, and phrasing patterns used in the message.

The term “level of detail” refers to the extent or granularity of information included in the notification message, such as the number of attributes, length of explanations, or amount of descriptive content provided.

The term “number of item candidates” refers to the count of items or item candidate entries whose information is included or referenced in a notification message or visual presentation.

In one embodiment, a server executes a recommendation program on a hardware platform including at least one processor, a main memory, a non-volatile storage device, and a network interface. The server uses a general-purpose operating system, such as a UNIX-based operating system, and an application framework, such as a web application framework, to provide network-accessible functions. The server implements a backend application using an interpreter or compiler for a high-level language, such as a scripting language, and uses libraries to access a relational database system and an external generative AI model via a network.

In one embodiment, a terminal comprises a client device such as a smartphone, a tablet device, or a personal computer, equipped with a display, an input interface, and a network interface. The terminal executes a web browser or dedicated client application to render an interactive user interface transmitted from the server. The terminal sends user input to the server and displays recommended items and notification content generated by the server.

In one embodiment, a user operates the terminal and provides input information that includes conditions related to an item, such as desired category, material, style, size, and budget. The user enters these conditions through graphical controls in the browser or client application. The user confirms the input for transmission to the server.

Server performs data processing on the received input information to extract requirement attributes. Server represents the input information in a structured data format, such as a key-value mapping in memory, and applies normalization rules, including conversion to canonical category identifiers, removal of extraneous characters, and mapping of free-text budget input to numeric ranges. Server stores the requirement attributes as records in a data structure held in main memory, such as an associative array or a row in an in-memory table. Server uses a database management system running on the same machine or on a remote machine, for example a relational database engine, to store and retrieve item information. Server accesses the database by executing query statements that specify constraints on attributes such as category, material, style, and price range. Server thereby obtains a set of item records that are preliminarily consistent with the requirement attributes. Server may also access indices on columns such as category and price to reduce query time, thereby improving processing speed relative to a naive full scan. Server generates a prompt sentence for a generative AI model based on the requirement attributes and optionally the preliminarily retrieved item records. Server constructs the prompt sentence using a template that includes fixed expressions and variable fields. Server inserts the values of requirement attributes into the variable fields and formats them as natural-language text. For example, server generates a prompt sentence such as:

“Based on the user's input conditions, please recommend the most suitable products. Conditions:
Category: T-shirt
Material: organic cotton
Style: casual
Budget: under 50 USD For each recommended product, output:
1) Product name,
2) Short description (1-2 sentences),
3) Approximate price in USD,
4) Why it matches the conditions.

Output the result as a numbered list.”

In another embodiment, server generates a prompt sentence such as:

“The user is looking for eco-friendly clothing items.

Please suggest 5 T-shirts that meet all of the following conditions:
Material: organic cotton
Design: simple casual design for daily wear
Sizes available: S to L
Price: Under 6,000 JPY

For each item, provide: product name, style description, material details, and price range. Use clear bullet points.”

In another embodiment, server generates a prompt sentence such as:

“A user wants a comfortable summer T-shirt.

Conditions:
Breathable organic fabric
Light colors
Casual design suitable for outdoor activities
Budget: up to 40 EUR

Please propose several product ideas and explain in 1-2 sentences for each how it satisfies the conditions. Structure the answer as a numbered list.”

Server then inputs the generated prompt sentence into a generative AI model. In one embodiment, the generative AI model is implemented as a transformer-based neural network trained for natural language generation. The generative AI model uses a tokenization module to convert characters and words of the prompt sentence into token identifiers, and then maps the token identifiers to embedding vectors. The generative AI model comprises multiple layers of self-attention and feedforward sublayers. Within each self-attention layer, the model computes query, key, and value vectors using learned weight matrices, and applies scaled dot-product attention followed by softmax operations to produce context-sensitive representations. The generative AI model subsequently applies non-linear activation functions, such as rectified linear unit functions, within feedforward layers to transform the intermediate representations.

Server sends the prompt sentence and associated parameters, such as maximum token length and sampling temperature, as input data to the generative AI model through an application programming interface accessible via the network interface. The generative AI model performs inference by propagating the embedding vectors through the transformer layers, computing attention weights and updated hidden states at each layer. The model iteratively predicts the next token by applying a final linear transformation and softmax function to produce a probability distribution over tokens. The model samples or selects tokens according to predetermined decoding rules, such as greedy decoding or nucleus sampling, thereby generating item candidate information as natural-language text.

Server receives the text output of the generative AI model as a response message. Server parses the response by applying text processing algorithms, such as splitting by line separators and detecting numerical prefixes, bullet points, and key expressions. Server converts each segment of the text into structured data representing an item candidate. Server assigns a data schema to each item candidate, including fields for item name, item description, price information, and suitability reason. Server may apply pattern matching rules and regular expressions to extract numeric price values and currency indicators, thus enabling numeric comparison and sorting operations.

Server performs ranking and filtering on the structured item candidate data. Server computes a degree of conformity for each item candidate by comparing the structured fields with the requirement attributes. In one embodiment, server assigns weights to different attributes, such as a higher weight to exact matches on material than to partial matches on style. Server calculates a weighted similarity score based on attribute matches and numeric differences in price with respect to the budget range. Server filters out candidates with scores below a predetermined threshold and orders the remaining candidates in descending order of similarity score. Server thereby obtains recommended item information suitable for presentation.

Server converts the recommended item information into a display data format tailored to the terminal. In one embodiment, server generates markup data describing item cards, including an image reference, title, short description, price display, and an interaction element such as a selection button or link. Server transmits this display data via the network interface to the terminal using a communication protocol such as HTTP. Server may compress the data payload and omit redundant fields, thereby reducing communication load.

Terminal receives the display data and renders it on the display using a browser or a native rendering engine. Terminal interprets markup tags, style information, and script instructions to construct visual components. Terminal presents the recommended item cards to the user, enabling the user to scroll, inspect details, and select items for further action such as purchasing or saving.

Server records, in an information storage device, the prompt sentences for generation, the corresponding responses from the generative AI model, and the recommended item information actually presented to the user. Server associates these records with identifiers that may correspond to a user session, a timestamp, or an interaction scenario. Server maintains this history information in a structured table that includes fields for requirement attributes, prompt templates used, model parameters at the time of inference, text output, parsing results, and ranking scores.

Server updates templates of prompt sentences and ranking conditions based on the stored history information. In one embodiment, server evaluates which prompt templates and ranking parameter sets lead to higher selection rates or lower correction rates for the recommended items. Server calculates performance metrics, such as click-through rate and user selection rate, using the stored history. Server then adjusts template text, such as adding explicit instructions for the model to output structured lists, or modifies ranking parameter weights to increase emphasis on attributes that correlate with successful recommendations. This feedback loop improves the stability and accuracy of recommendations and constitutes an adaptation mechanism implemented by the processor.

From a technical perspective, server improves computer technology in several respects. Server reduces the amount of manual rule design needed to capture complex user preferences by using a generative AI model that operates over structured prompt sentences. However, server does not simply replace human judgment; instead, server integrates the generative model within a deterministic data pipeline that enforces structured parsing, ranking, and historical optimization. This integration leads to improved data management, as server converts unstructured text into structured records that can be indexed and queried like conventional database data.

Server improves processing efficiency by using requirement attributes to pre-filter items in the database, thereby narrowing the search space before invoking the generative AI model and before performing ranking. Server also reduces communication overhead with the generative AI model by constructing compact prompt sentences that contain minimal but sufficient structured information. By storing history and improving templates and ranking conditions automatically, server reduces repeated trial-and-error transmissions and stabilizes the model's output, which can reduce compute usage on the external inference infrastructure. Server further improves accuracy of recommendations by combining the generative AI model's language understanding with structured scoring functions tailored to the requirement attributes. Because the generative AI model uses a multi-layer transformer architecture trained with gradient-based optimization and loss functions such as cross-entropy, the model can capture semantic relationships between words in the prompt sentence, enabling the system to infer nuanced preferences. Server then constrains the generative output via filtering and ranking rules that may incorporate domain-specific scoring, thereby reducing noise and misalignment that would arise if the generative output were used directly.

In one embodiment, the generative AI model has been trained using a large corpus of text data by minimizing a prediction error between predicted tokens and ground-truth tokens through backpropagation and weight updates. The training process involves a loss function, such as cross-entropy loss, and an optimizer, such as stochastic gradient descent with momentum or adaptive gradient methods. During training, the model parameters, including weights of attention layers and feedforward layers, are iteratively updated based on gradients computed from batches of training data. This training methodology enables the model to generalize to unseen input prompt sentences at inference time.

In one embodiment, server uses rule-based parsing and scoring that differ from conventional human evaluation processes. Server applies consistency rules designed specifically for machine-readable output, such as requiring each candidate item to start with a numeric label or requiring price information to appear with a currency symbol. Server imposes non-conventional constraints in the prompt sentence to enforce this structured formatting. This design allows the processor to parse and evaluate candidate items using purely algorithmic procedures without relying on subjective or manual interpretation, thereby providing a technical advantage over prior systems that are either entirely rule-based or entirely unstructured.

In one embodiment, server cooperates with an external communication application to deliver notification messages containing summary content and links to recommended items. Server automatically generates the summary content by selecting key attributes from the structured recommended item data. Server adjusts the writing style, level of detail, and number of candidates mentioned in the notification based on user-specific patterns observed in the history information, such as a user's tendency to respond to short summaries or detailed descriptions. This dynamic adjustment is implemented using explicit parameter values stored in the history table, not as a mere automation of human behavior, and results in more efficient use of communication bandwidth and improved relevance of notifications.

In other embodiments, server uses different generative AI models or architectures, such as models with fewer layers for resource-constrained deployments or models optimized for shorter sequences. In yet another embodiment, server executes the generative AI model locally on a specialized accelerator device, such as a graphics processing unit or tensor processing unit, allowing the recommendation pipeline to operate within a closed network environment with reduced latency and improved control over data privacy.

In another embodiment, server interacts with multiple terminals simultaneously. Server maintains separate user contexts and history information for each terminal or user account, and may employ different ranking conditions or prompt templates depending on the device type, such as a mobile terminal or a desktop terminal. This allows optimization of display data structures and prompt content to the capabilities and usage patterns of each terminal class, thereby enhancing overall system performance.

In another embodiment, server supports additional item domains beyond clothing, such as electronic devices, household goods, or digital content. Server adapts the requirement attributes and prompt templates to the specific domain, such as including technical specifications for electronic devices or compatibility attributes for digital content. The underlying processing pipeline extraction of requirement attributes, generation of a structured prompt sentence, inference by a transformer-based generative AI model, structured parsing, ranking, and historical optimization remains the same, thereby demonstrating the flexibility of the technical solution while preserving its core computational improvements.

Through these embodiments, server, terminal, and user cooperate in a configuration where the server performs structured data extraction, generative AI integration, and systematic post-processing, the terminal provides interaction and display functions, and the user supplies conditions and feedback. The described architecture and algorithms enable the system to achieve higher recommendation accuracy, improved computational efficiency, better data management, and reduced communication overhead compared with conventional systems that either rely solely on static rule-based processing or use generative models in an unstructured, non-integrated manner.

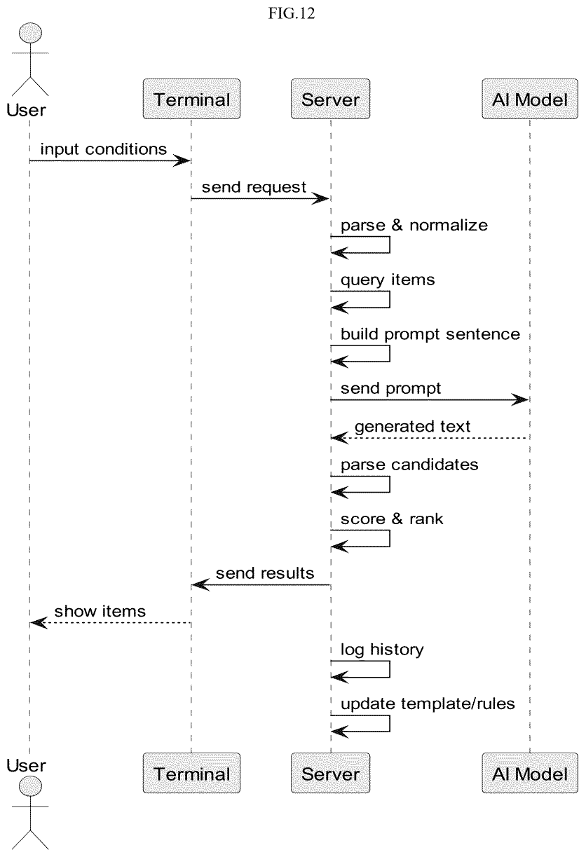

The following describes the processing flow using FIG. 12.

### Step 1:

User operates the terminal and inputs item conditions through a graphical user interface. User supplies input information such as desired category, material, style, size, and budget by typing into text fields, selecting from drop-down lists, and toggling checkboxes. The input of this step is the user's raw intention expressed as interactions with the UI controls, and the output is a set of UI field values held in the terminal's local memory (for example, strings and selected option identifiers).

### Step 2:

Terminal constructs a request message containing the field values and transmits the message to the server. Terminal serializes the UI field values into a structured format such as key-value pairs, including keys like “category,” “material,” “style,” and “budget.” The input of this step is the UI field values stored locally, and the output is a network request payload formatted, for example, as JSON or form-encoded text, which the terminal sends to the server over a network protocol.

### Step 3:

Server receives the request message and parses the input information into an internal data structure. Server reads the network payload, decodes the structured format, and constructs an in-memory representation such as a mapping from keys to values. The input of this step is the serialized request payload from the terminal, and the output is a structured data object containing the user's raw conditions as text values ready for further processing.

### Step 4:

Server normalizes and validates the structured data to derive requirement attributes. Server applies data-processing operations such as trimming whitespace, converting characters to a standard case, mapping free-form category names to canonical category identifiers, and converting budget expressions into numeric ranges. The input of this step is the unnormalized structured data object, and the output is a refined set of requirement attributes represented as standardized fields, for example, “category_id,” “material_keywords,” “style_keywords,” and “budget_min/budget_max.”

### Step 5:

Server queries an information storage device to obtain preliminarily matching item records. Server uses the requirement attributes to construct a database query that filters items by category, material, style, and price constraints. The input of this step is the set of normalized requirement attributes, and the output is a collection of item records retrieved from the database, each record represented as a structured row including item identifiers, attribute values, and possibly stock or availability information.

### Step 6:

Server generates a prompt sentence for the generative AI model based on the requirement attributes and optionally the preliminarily matching item records. Server applies a prompt template, inserting attribute values into predefined positions and formatting the data as coherent natural-language text. The input of this step is the requirement attributes (and optionally summary information from the retrieved item records), and the output is a prompt sentence, for example:
“Based on the user's input conditions, please recommend the most suitable products. Conditions:
Category: T-shirt
Material: organic cotton
Style: casual
Budget: under 50 USD

For each recommended product, output:
1) Product name,
2) Short description (1-2 sentences),
3) Approximate price in USD,
4) Why it matches the conditions.
Output the result as a numbered list.”

### Step 7:

Server transmits the prompt sentence and inference parameters to the generative AI model through an interface. Server constructs a request that includes the prompt sentence, the designated model identifier, maximum output length, and decoding parameters such as temperature or top-p. The input of this step is the text of the prompt sentence and related configuration values, and the output is a model-inference request message that is sent to the generative AI model over a communication channel.

### Step 8:

Generative AI model performs text generation processing and returns item candidate information. The generative AI model tokenizes the prompt sentence into tokens, maps tokens to vector embeddings, and propagates these through multiple transformer layers that compute attention scores and updated hidden states, ultimately predicting output tokens that form candidate item descriptions. The input of this step is the encoded prompt sentence and model parameters, and the output is a generated text response that includes a list of item candidates described in natural language.

### Step 9:

Server receives the text response from the generative AI model and segments it into individual item candidate entries. Server uses text-processing routines to split the output by line breaks, numeric labels, or bullet markers, and identifies boundaries between separate candidate descriptions. The input of this step is the single block of generated text, and the output is a list of raw text segments, each segment corresponding to one candidate item.

### Step 10:

Server converts the raw text segments into structured item candidate data. Server applies pattern matching to each segment to extract fields such as item name, description, price expression, and suitability reason. Server may use keyword detection and regular expressions to identify price values and currency symbols, and assigns the parsed results to a predefined data schema. The input of this step is the list of raw text segments, and the output is a list of structured candidate records, each record containing at least a name field, a description field, a numeric or range-based price field, and a suitability_reason field.

### Step 11:

Server calculates a degree of conformity between each structured candidate record and the requirement attributes and performs filtering. Server compares candidate attributes with the requirement attributes, computes similarity or match scores using weighted contributions for different fields, and discards candidates whose scores fall below a predetermined threshold. The input of this step is the list of structured candidate records and the requirement attributes, and the output is a reduced list of candidate records that satisfy the minimum conformity criteria.

### Step 12:

Server ranks the filtered candidate records according to their degrees of conformity. Server sorts the candidate list in descending order of the computed scores and may break ties using secondary criteria such as price proximity to the target budget or alignment with preferred materials. The input of this step is the filtered list of candidate records with associated scores, and the output is an ordered list of recommended item information, where each entry's position reflects its relative suitability.

### Step 13:

Server formats the ordered recommended item information into a display data format suitable for presentation on the terminal. Server constructs visual descriptors such as item titles, descriptive snippets, formatted price strings, and links or identifiers for further interaction. The input of this step is the ranked list of recommended item records, and the output is structured display data, such as markup or UI-component descriptions, ready to be transmitted to the terminal.

### Step 14:

Server sends the display data to the terminal for visual presentation to the user. Server packages the display data into a response message and transmits it using a communication protocol. The input of this step is the prepared display data structure, and the output is a response payload delivered over the network to the terminal.

### Step 15:

Terminal receives the response payload and renders the recommended items on its display. Terminal interprets the display data, constructs visual elements such as item cards or list entries, and arranges them on the screen. The input of this step is the received display payload from the server, and the output is a graphical user interface showing recommended item details that the user can see and interact with.

### Step 16:

User reviews the presented recommended items on the terminal and optionally selects an item or adjusts conditions. User may tap or click on an item to view more details or may modify the original conditions and trigger a new recommendation cycle. The input of this step is the visible recommendation interface, and the output is new user actions or feedback that can be captured by the terminal for subsequent processing.

### Step 17:

Server records the interaction history, including the requirement attributes, the prompt sentence, the response text, and the final recommended item information. Server stores these elements in an information storage device as structured records associated with timestamps and user or session identifiers. The input of this step is the set of data generated and used during the recommendation cycle, and the output is persistent history information stored in a retrievable form.

### Step 18:

Server analyzes the stored history to adjust prompt templates and ranking conditions. Server computes performance indicators such as selection rates for top-ranked items, consistency of model output formatting, and parsing success rates. Based on these metrics, server modifies template phrases (for example, adding more explicit instructions to structure the model output) and updates ranking weights to emphasize attributes that correlate with successful user selections. The input of this step is the accumulated history information and computed performance metrics, and the output is updated configuration data, including refined prompt templates and adjusted ranking parameters, which will influence subsequent executions of the recommendation process.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recruitment information systems generally rely on fixed-form input fields and predefined filters, such as department selections and checkboxes for work styles, to retrieve recruitment information from a database. In such systems, when a user expresses desired conditions in free-form natural language, the system cannot accurately interpret the intent of the user, and therefore the system either fails to execute an appropriate search or requires the user to manually translate the intent into rigid filter settings. As a result, there is a technical problem that the information processing performed by the computer is not optimized for natural-language input and leads to increased processing overhead on the user side and suboptimal use of computing resources on the server side.

Further, conventional systems do not take into account the emotional state of the user when generating search instructions or presenting search results. As a consequence, system behavior such as generation of search queries and presentation of matching results is insensitive to user sentiment, which can lead to inefficient interaction loops, unnecessary repeated queries, and increased network and processor load due to trial-and-error operations by the user.

Moreover, existing techniques that simply call a generative AI model to return textual recommendations do not tightly integrate the model output into structured query generation and database search. In these techniques, the generative model output often remains unstructured text, which must be interpreted manually or with additional ad hoc processing, causing redundant computation, ambiguity in mapping to database fields, and latency in end-to-end response time.

Accordingly, there is a need for an improved computer-implemented recruitment information processing technique in which a processor can: (i) automatically interpret a user's natural-language input, including emotional context, using a generative AI model; (ii) convert the interpreted intent into structured condition information; (iii) generate optimized database queries in a deterministic and secure manner; and (iv) provide search and matching results to the user terminal in a form adapted to the user's emotional state. Such a technique would improve the overall efficiency, accuracy, and responsiveness of the computer system itself, reduce unnecessary user operations, and enhance the utilization of computational and communication resources.

The specific processing by the specific processing unit 290 of the data processing device 12 in Example 2 is realized by the following means.

The present invention provides a server comprising a processor, the processor being configured to receive input information from a user, analyze the input information and recognize an emotional state of the user, generate a prompt sentence including natural language based on the input information and an analysis result regarding the emotional state, transmit the prompt sentence to a generative AI model and obtain, from the generative AI model, structured condition information representing desired conditions of the user, generate a query expression using the structured condition information and transmit the query expression to a database search engine to search recruitment information stored in a storage device, generate a matching result between the user and a recruitment entity based on recruitment information obtained by the search, and convert the matching result into output information and notify the matching result to a user terminal via a communication interface. This enables the computer system to automatically transform emotionally nuanced natural-language input into machine-optimized structured queries, thereby improving the technical performance of the recruitment information processing pipeline, including increased accuracy of database searches, reduced interaction latency, and more efficient utilization of processing and network resources while providing results in a manner adapted to the user's emotional state.

The term “input information” refers to information provided from a user to the system, including at least natural-language text and optionally structured selections such as departments, work styles, and experience levels, which are used as a basis for subsequent analysis and processing by the processor.

The term “emotional state” refers to a condition of user sentiment, such as positive, negative, neutral, or more fine-grained affective categories, inferred by the processor from the input information using an emotion recognition algorithm or model.

The term “prompt sentence” refers to a sequence of natural-language tokens generated by the processor and supplied as an instruction to a generative AI model, the prompt sentence specifying how the generative AI model should interpret the user's intent and what type of output should be returned.

The term “generative AI model” refers to a machine learning based information processing model, such as a large language model, configured to receive a prompt sentence as input and generate as output text or data including at least structured condition information representing the user's desired conditions.

The term “structured condition information” refers to information in a structured data format, such as key-value pairs, records, or objects, that encode the user's desired conditions in a machine-interpretable form suitable for direct use in generating query expressions for a database search engine.

The term “query expression” refers to a machine-readable search instruction, such as a database query statement, generated by the processor using the structured condition information, and configured to be executed by a database search engine to retrieve recruitment information from a data store.

The term “database search engine” refers to software executed by a computing apparatus that receives a query expression, searches one or more data structures storing recruitment information, and returns search results that match conditions specified in the query expression.

The term “recruitment information” refers to information stored in a data store and associated with recruitment opportunities, including at least department identifiers, job descriptions, required skills, work styles, and eligibility conditions.

The term “recruitment entity” refers to an organizational unit or other recruiting party associated with recruitment information in the data store, such as a department, team, or business unit offering a recruitment opportunity.

The term “matching result” refers to information generated by the processor that indicates a relationship between the user and one or more recruitment entities, based on correspondence between the structured condition information and the recruitment information retrieved by the database search engine.

The term “output information” refers to data derived from the matching result and formatted by the processor for presentation to the user, including at least identifiers of recruitment entities, summaries of recruitment information, and explanatory text adapted to the user.

The term “user terminal” refers to an information processing apparatus operated by the user, such as a client device including an input interface, a display interface, a communication interface, and an execution environment for an application configured to transmit input information and receive and display output information.

The term “communication processing” refers to processing performed by the server and the user terminal to exchange data over a communication network, including at least transmission of the prompt sentence, the structured condition information, the query expression, the matching result, and the output information.

The term “communication application” refers to a software component that executes on the server or the user terminal and is configured to control communication processing, including formatting, transmitting, receiving, and routing messages associated with input information and output information.

In one embodiment, a server includes at least one processor, a memory device, a network interface, and a non-transitory storage device storing recruitment information and program instructions. A terminal includes at least one processor, a display device, an input device, a memory device, and a communication interface. A user operates the terminal to interact with the server over a communication network.

The server executes an operating system, a web server application, an application framework, a database management system, and a generative AI model execution environment. For example, the server uses a general-purpose operating system, a hypertext transfer protocol server, an application framework implemented in a high-level programming language, a relational database management system such as a generic SQL database engine, and a model runtime such as a transformer-based language model framework. The database management system runs on the server and manages relational tables stored on a magnetic or solid-state storage device. Recruitment information is stored in relational tables including, for example, a posting table, a department table, and a candidate profile table.

The terminal executes an operating system, a web browser or a native application, and a communication application. The terminal uses a touch panel or keyboard as the input device and a liquid crystal display or an organic light-emitting display as the output device. The terminal uses a wireless communication module such as a wireless local area network module or a cellular communication module as the communication interface.

The user uses the terminal to access a user interface screen provided by the server. The terminal displays an input field that allows the user to enter a natural-language prompt sentence, as well as optional selection controls such as department selectors and work-style toggles. The user inputs, for example, the following prompt sentences:

“Tell me internal recruitment information for departments in the sales division that have introduced a flex-time system.”

“I want internal recruitment postings in the IT department that allow remote work and a flex-time system.”

“Show me IT department postings that allow remote work, do not require weekend work, and need at least three years of software development experience.”

The terminal converts the user's text input and selection states into structured request data and transmits the request data to the server via a secure communication protocol. The server receives the request data through the network interface and stores the data in the memory device for subsequent processing.

The server uses an emotion recognition module to analyze the input information and recognize an emotional state of the user. In one embodiment, the emotion recognition module is implemented as a neural network model distinct from the generative AI model. The emotion recognition model may be a recurrent neural network, a convolutional neural network applied to token embeddings, or a transformer-based classifier. The server tokenizes the input text, maps the tokens to vector representations using an embedding matrix stored in memory, and feeds the embedded sequence into the emotion recognition model. The emotion recognition model outputs an emotion vector representing probabilities for categories such as positive, negative, neutral, frustration, or urgency. The server uses this emotion vector as the analysis result regarding the emotional state.

The server uses a prompt-generation module to construct a prompt sentence for a generative AI model. The prompt-generation module concatenates system-level instructions, the recognized emotional state, and the original user text into a structured natural-language instruction. For example, the server generates a prompt sentence including a system directive such as:

“Interpret the following user request regarding recruitment postings. Extract department, desired work style, experience requirement, and any exclusion conditions. Return the result in a structured format with keys: department, remote_work, flex_time, min_experience_years, weekend_work, required_skill. User emotional state: ‘frustrated’. User request: ‘Show me IT department postings that allow remote work, do not require weekend work, and need at least three years of software development experience.’”

In another embodiment, the server adapts the wording and level of detail of the prompt sentence based on the emotional state. For instance, when the emotion recognition module detects frustration, the server instructs the generative AI model to generate narrower and more explicit conditions to reduce the number of iterations and thereby decrease processing time and network traffic.

The server executes a generative AI model implemented as a transformer-based neural network with multiple self-attention layers, feed-forward layers, and positional encodings. The model is parameterized by a set of weight matrices stored in the memory device and is pre-trained on a large corpus of natural-language text and optionally fine-tuned on recruitment-related data. The server provides the generated prompt sentence to the generative AI model through a model runtime. The model runtime converts the text into token identifiers, applies learned embeddings, and iteratively processes the token sequence through attention and feed-forward operations to produce probability distributions over output tokens. The server constrains the generative AI model output to a structured format by including explicit instructions and examples of key-value pairs in the prompt sentence. The server parses the generated text to extract structured condition information. In one embodiment, the server uses pattern matching and rule-based parsing to map substrings to canonical keys and data types, such as mapping “IT department” to a department key, “allow remote work” to a boolean work-style flag, and “three years of software development experience” to a numeric minimum-experience value and a skill label. This combination of transformer-based generation and deterministic parsing ensures that the structured condition information is machine-interpretable and consistent with the database schema.

The server uses a query-generation module to convert the structured condition information into a query expression for a database search engine. The server maps each element of the structured condition information to predefined column identifiers and predicates. For example, the server maps “department: IT” to a predicate on a department name column, maps “remote_work: true” to a predicate on a remote-work flag column, maps “flex_time: true” to a predicate on a flex-time flag column, and maps “weekend_work: false” to a predicate on a weekend-work flag column. The server uses a parameterized query builder, not simple string concatenation, to insert parameter values into placeholder positions and to ensure secure and deterministic query formation.

The server executes the query expression using the database search engine. The database engine retrieves relevant rows from recruitment information tables, using indexes on department, work-style flags, and other frequently queried columns. The server loads the resulting rows into the memory device, converts them into internal data objects, and applies additional ranking or filtering logic. For example, the server can sort results by posting date, priority score, or similarity to user preferences previously stored in a user profile table.

The server generates a matching result between the user and recruitment entities by associating the user with each retrieved posting that satisfies the structured condition information. The matching result includes identifiers of recruitment entities, summaries of job positions, and a confidence or relevance score. The server formats the matching result into output information suitable for display on the terminal, taking into account the emotional state of the user. When the emotion recognition module indicates that the user is frustrated or overwhelmed, the server may limit the number of results, group similar postings, and add explanatory text that clarifies why each posting was selected. This adaptive formatting reduces the cognitive load on the user and simultaneously reduces bandwidth usage by sending only the most relevant subset of data.

The terminal receives the output information and renders it using a graphical user interface.

The terminal displays each recruitment posting with fields such as department name, job title, work style, required experience, and work schedule constraints. The terminal may offer interactive controls that allow the user to refine the search conditions through new prompt sentences. Because the server has already derived a mapping between natural-language conditions and database fields, subsequent iterations can be processed quickly and with fewer round trips and misinterpretations.

This configuration produces technical improvements beyond mere automation of human judgment. The server uses the generative AI model to transform ambiguous natural-language input into structured condition information that is tightly bound to database columns and query predicates. This transformation reduces the number of invalid or inefficient queries, decreases processing cycles wasted on irrelevant database scans, and improves cache efficiency in the database engine due to more uniform and predictable query patterns. The server's deterministic parsing and query-generation logic prevent the generative AI model from issuing arbitrary queries, which improves system stability and reduces the risk of malformed search instructions.

The emotion-aware prompt generation further improves system performance. By adapting the specificity and style of the prompt sentence to the detected emotional state, the server reduces the average number of interaction cycles required for a user to obtain satisfactory results. This reduction decreases cumulative processor usage on both the server and the terminal, lowers network traffic, and shortens overall response times. The server's use of structured condition information as an intermediate representation constitutes a specific data structure that organizes the user's intent into a compact, machine-optimized format, which is re-used across query-generation, ranking, and presentation modules.

The generative AI model itself is implemented with a specific network architecture and training procedure. The server trains the model using a supervised learning process that minimizes a language-modeling loss function, such as cross-entropy between predicted and actual tokens, and fine-tunes the model on domain-specific prompts and structured outputs. The server uses an optimization algorithm, such as stochastic gradient descent with adaptive learning rate scheduling, to update the model's weight parameters during training. The server optionally uses data augmentation techniques, such as paraphrasing and synonym replacement, to increase robustness to variations in user language. These details demonstrate that the generative AI model is not a black-box decision engine but an engineered component whose internal operations contribute directly to technical performance.

The server uses the emotion recognition model and the generative AI model in combination and according to non-conventional control logic. The server does not merely classify emotion and then pass the same text to a model. Instead, the server encodes the emotional state into the content and structure of the prompt sentence and into the subsequent formatting of results. This non-standard control flow changes how the generative AI model operates, which phrases it generates, and thus which conditions are extracted. The result is a measurable decrease in mismatches between user intent and retrieved postings, which leads to fewer correction queries and improved throughput in the recruitment information processing pipeline.

In a variation, the server integrates a caching mechanism that stores previously computed structured condition information and corresponding query templates. When a new prompt sentence is semantically similar to a prior one, the server can bypass a full generative AI inference by reusing or slightly adjusting cached structured condition information. The server measures similarity using vector representations of prompt sentences generated by the same transformer-based model or a related encoder. This approach yields additional technical benefits by reducing the number of compute-intensive model invocations, decreasing energy consumption and improving response time.

In another embodiment, the server uses a hybrid rule-based and model-based pipeline for structured condition extraction. The server defines domain-specific rules that map certain phrases directly to condition keys and uses the generative AI model for resolving ambiguities and understanding novel phrasing. This hybrid approach reduces the amount of generative computation needed while maintaining flexibility for new expressions. The server thereby achieves improved computational efficiency and stability compared to systems that rely solely on generative outputs or solely on rigid rules.

In yet another embodiment, the terminal performs some pre-processing of the user's prompt sentence, such as language detection, tokenization, or client-side validation of basic structure, before sending data to the server. This pre-processing reduces the server's workload and lowers latency by offloading simple text operations to the terminal processor. The server's program instructions are designed to operate with such pre-processed data but can also fall back to server-side processing when the terminal has limited capability.

The described embodiments demonstrate that the system is not limited to a generic sequence of receiving data, analyzing data, and displaying results. Instead, the server and the terminal cooperate through specific data structures (structured condition information, emotion vectors, query templates), specific neural network architectures (transformer-based generative model, emotion recognition classifier), and specific control logic (emotion-aware prompt generation, deterministic parsing, parameterized query formation), which collectively improve the functioning of the computer system as a data processing apparatus. As a result, the system achieves higher search accuracy, reduced processing time, more efficient database utilization, and lower communication overhead compared to conventional recruitment information systems that do not employ such integrated generative AI and emotion-aware processing.

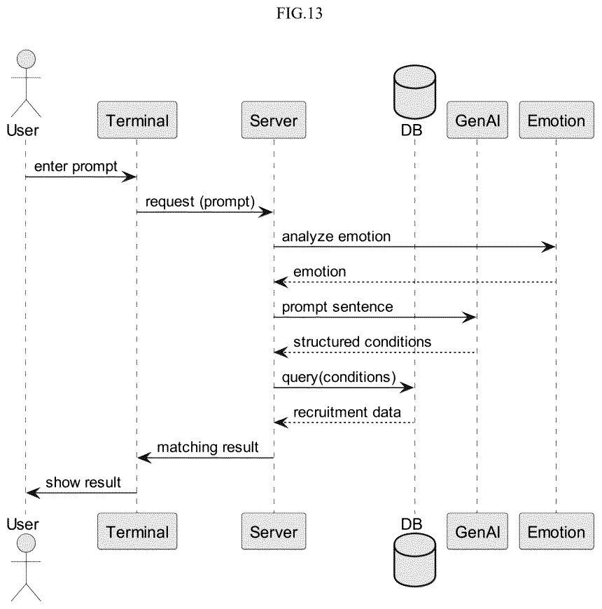

The following describes the processing flow using FIG. 13.

### Step 1:

User operates the terminal to open an application screen or web page that includes an input field for a natural-language prompt sentence and optional selection controls.
User inputs, via a keyboard or touch panel, text such as “Show me IT department postings that allow remote work, do not require weekend work, and need at least three years of software development experience.” and optionally selects checkboxes or dropdown values.
Terminal takes, as input, raw keystroke or touch events and current UI control states, and converts them into a structured request object including at least a text field for the prompt sentence and fields for selected options.
Terminal outputs the structured request object and temporarily stores it in local memory in preparation for transmission.

### Step 2:

Terminal packages the structured request object into a message suitable for network transmission.
Terminal takes, as input, the structured request object from Step 1, and serializes the object into a data format such as a JSON string, while adding metadata such as a user identifier and a timestamp.
Terminal performs data processing by encoding the JSON string into bytes, attaching HTTP headers, and encrypting the message using a transport-layer security protocol.
Terminal outputs an encrypted network packet stream and sends the stream to the server via a wireless or wired communication interface.

### Step 3:

Server receives the encrypted network traffic from the terminal through a network interface. Server takes, as input, the encrypted packet stream from Step 2, and uses a decryption algorithm implemented in a transport security library to reconstruct the original HTTP request.
Server parses the HTTP headers and the body, decodes the JSON string, and converts the JSON data into internal data structures such as key-value maps or objects.
Server outputs an internal representation of the user request, including at least the prompt sentence, any explicit filter options, and a user identifier, and stores this representation in main memory.

### Step 4:

Server executes an emotion recognition module to determine the emotional state of the user from the input information.
Server takes, as input, the prompt sentence and optionally historical interaction data associated with the user identifier.
Server performs data processing by tokenizing the prompt sentence into tokens, embedding the tokens into numerical vectors, and feeding the sequence into a trained classifier model that computes an emotion probability vector.
Server outputs an emotion label (for example, “neutral” or “frustrated”) and an associated confidence score, and stores these as emotion analysis results linked to the current request.

### Step 5:

Server generates a prompt sentence for the generative AI model by combining the user's original text with system-level instructions and the detected emotional state.
Server takes, as input, the internal representation of the user request from Step 3 and the emotion analysis results from Step 4.
Server performs data processing by inserting the prompt sentence into a predefined template that specifies required output keys (such as department, remote_work, flex_time, min_experience_years, weekend_work, required_skill) and by appending text that describes the user's emotional state to influence the response style.
Server outputs a composed instruction text, which serves as the final prompt sentence for the generative AI model.

### Step 6:

Server invokes the generative AI model to convert the prompt sentence into structured condition information.
Server takes, as input, the composed prompt sentence from Step 5, and tokenizes the prompt sentence into model-specific tokens.
Server performs data processing by feeding the token sequence into a transformer-based neural network that applies attention operations and feed-forward transformations across multiple layers to generate output tokens predicting a structured description of conditions.
Server decodes the output tokens into text, applies pattern recognition and rule-based parsing to extract key-value pairs for department, remote_work, flex_time, min_experience_years, weekend_work, and required_skill.
Server outputs structured condition information in an internal data structure, such as a dictionary or record, and stores this alongside the request.

### Step 7:

Server merges the structured condition information with any explicit filter options specified by the user.
Server takes, as input, the structured condition information from Step 6 and the explicit options from Step 3.
Server performs data processing by applying precedence rules, such as letting explicit user selections override conflicting generated conditions, and by normalizing values to canonical formats used by the database schema.
Server outputs a unified condition set, including normalized department identifiers, boolean flags for remote_work, flex_time, weekend_work, and numeric values for min_experience_years, and stores this as the final search condition set.

### Step 8:

Server constructs a query expression for a database search engine based on the unified condition set.
Server takes, as input, the unified condition set from Step 7 and the schema definition of recruitment information tables stored in memory.
Server performs data processing by mapping each condition key to a column name and generating a parameterized query template that includes placeholder positions for condition values; the server binds the actual values to these placeholders without direct string concatenation, thereby generating a safe and optimized database query.
Server outputs a query expression, such as a parameterized SQL statement object, along with a list of bound parameter values.

### Step 9:

Server executes the query expression using the database search engine and retrieves matching recruitment information.
Server takes, as input, the parameterized query and parameter values from Step 8.
Server performs data processing by submitting the query to a database management component, which scans indexes and table data to locate rows whose column values satisfy the specified predicates; the database engine returns a result set to the server.
Server outputs a collection of recruitment records, each represented by fields such as department identifier, job title, work style flags, experience requirements, and schedule constraints.

### Step 10:

Server generates a matching result between the user and recruitment entities from the retrieved recruitment records.
Server takes, as input, the recruitment records from Step 9 and optionally user profile data stored in persistent storage.
Server performs data processing by evaluating how closely each recruitment record satisfies the unified condition set and computing a relevance score, sorting or ranking the records according to the relevance score, and selecting a subset if necessary to limit result size.
Server outputs a matching result object that includes identifiers of selected recruitment entities, summaries of associated recruitment information, and relevance metrics.

### Step 11:

Server formats the matching result into output information adapted to the user's emotional state.
Server takes, as input, the matching result object from Step 10 and the emotion analysis results from Step 4.
Server performs data processing by choosing a presentation style (for example, concise versus detailed descriptions), grouping or filtering the results according to emotion-based rules, and generating textual explanations that indicate why each posting is included, all while packaging the data into a structured response format such as JSON.
Server outputs an output information message ready for network transmission to the terminal.

### Step 12:

Server transmits the output information to the terminal via the communication interface.
Server takes, as input, the structured output information from Step 11, and serializes it into a message body, attaches response headers, and encrypts the message using the transport security protocol.
Server performs data processing by fragmenting the encrypted data into network packets and sending these packets through the network interface to the terminal.
Server outputs an encrypted response stream on the network, which carries the matching result to the terminal.

### Step 13:

Terminal receives and decodes the output information from the server.
Terminal takes, as input, the encrypted response stream from Step 12, and uses a decryption module to reconstruct the original response message.
Terminal parses the response headers and body, decodes the structured data (for example, JSON) into internal data structures, and stores the resulting objects in memory for display logic.
Terminal outputs an internal representation of the matching result, including lists of recruitment postings and associated metadata.

### Step 14:

Terminal renders the matching result on the display and supports further user interaction.
Terminal takes, as input, the internal representation of the matching result from Step 13 and current user interface state.
Terminal performs data processing by generating visual components such as lists, detail panels, and icons that represent remote work, flex-time, and weekend-work conditions, and by arranging these components according to layout rules that may be adapted to the user's emotional state (for example, showing fewer, clearer entries when frustration is detected).
Terminal outputs a graphical display that presents the selected recruitment postings to the user and updates input controls so that the user can enter a new prompt sentence or refine conditions, which in turn can be used as new input for repeating Steps 1 through 14.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional matching systems that associate users with internal recruitment opportunities or allocation targets (such as organizational positions, work shifts, or service resources) generally rely on rigid rule-based filtering and static templates for user notification. Such systems suffer from several technical drawbacks in terms of computer technology.
First, existing systems typically process user input as simple structured fields without deeply analyzing free-text content or emotional nuance. As a result, back-end processing components cannot effectively leverage the full expressive information carried in user text, which leads to suboptimal use of computing resources and low-quality matching results when operating over large-scale databases of candidate information.
Second, conventional systems treat matching computation, natural-language generation, and user notification as separate and loosely coupled modules. User terminals send form inputs, back-end processors perform database queries, and then fixed notification templates are populated. This architecture does not exploit recent advances in generative AI models in a coordinated way with structured matching logic. Consequently, the processor cannot dynamically generate context-aware prompt sentences that accurately convey the current candidate space, user preferences, and user emotional state to a generative AI model. This lack of integration prevents the system from obtaining high-quality, machine-generated explanations and recommendations in real time, particularly under constraints of latency and processing load.
Third, prior systems provide emotionally neutral or simplistic notifications. These systems do not adjust notification tone or content according to a detected emotional state of the user. In practice, this can cause a mismatch between the user's psychological state and the form of the system's output, reducing user engagement and potentially leading to additional back-and-forth queries that burden network resources and server processing.
Fourth, in many enterprise environments, notifications must be delivered over heterogeneous external communication services, such as messaging platforms and email systems. Traditional systems often implement such integrations in an ad hoc manner, duplicating logic and data transformations for each external service. This results in inefficient message generation pipelines, redundant network transmissions, and difficulty in centrally governing how matching results and explanations are formatted and delivered.

Accordingly, there is a need for an improved computer-implemented system and method that: (i) systematically extracts both emotional state and preference conditions from user input at the server side; (ii) uses this information to drive an integrated pipeline of database search, candidate ranking, prompt sentence generation, and invocation of a generative AI model; (iii) associates the generative AI model's output with structured internal records to produce coherent matching result data; and (iv) automatically adjusts notification content and tone and delivers such notifications through both local terminals and external communication services in a unified, computationally efficient manner. The technical problem to be solved is to provide a server-side processing architecture that improves the quality, relevance, and efficiency of user-resource matching and notification by tightly coupling emotion-aware analysis, structured data processing, and generative AI model interaction within a single coordinated control flow.

The specific processing by the specific processing unit 290 of the data processing device 12 in Application Example 2 is realized by the following means.

The present invention provides a server comprising a processor configured to receive input information from a user terminal; analyze the received input information to extract an emotional state of a user and preference conditions of the user; search, based on the extracted emotional state and the extracted preference conditions, recruitment information or allocation target information stored in an internal information storage unit to obtain candidate information; compare the candidate information with the preference conditions of the user, calculate suitability scores for respective candidates, and rank the candidates based on the suitability scores; generate a prompt sentence including an instruction content for a generative AI model, a summary of the ranked candidate information, and a notification tone, based on the emotional state and the ranked candidate information; input the generated prompt sentence into the generative AI model and obtain a generation result including at least one recommended target among the candidates and a reason for recommendation; associate and integrate the generation result with structured information stored in the internal information storage unit to generate matching result data to be presented to the user; generate notification content based on the matching result data and adjust an expression of the notification content according to the emotional state of the user; and transmit the adjusted notification content and the matching result data to the user terminal and/or an external communication service for display. This enables the server to implement, within a single coordinated computational pipeline, emotion-aware extraction of user intent, efficient search and ranking over large internal datasets, targeted generation of prompt sentences for a generative AI model, and integrated production and multi-channel delivery of matching results and explanations, thereby improving the technical performance, responsiveness, and contextual relevance of a computer-implemented matching system.

The term “processor” refers to a hardware processing unit or a combination of hardware processing units configured to execute computer-readable instructions to perform the functions described herein.

The term “user terminal” refers to an information processing apparatus operated by a user, such as a personal computer, a mobile terminal, or another communication-capable device, which transmits input information to the server and receives notification content from the server.

The term “input information” refers to data provided by a user via the user terminal, including at least one of free-text content, structured fields, and selection inputs that express the user's preferences, conditions, or intentions.

The term “emotional state” refers to information representing a psychological condition of the user, such as stress, motivation, satisfaction, or desire for flexibility, which is estimated by analysis of the input information.

The term “preference conditions” refers to constraints or desired attributes specified by the user, such as job category, work location, work schedule, skills, or other matching-related requirements.

The term “internal information storage unit” refers to a storage subsystem, such as a database system or memory device, that stores structured data including recruitment information, allocation target information, and other candidate information used by the processor.

The term “recruitment information” refers to structured data representing available opportunities for assignment, such as positions, departments, or roles that can be matched with a user.

The term “allocation target information” refers to structured data representing resources, sites, shifts, or other allocation destinations with which a user can be associated.

The term “candidate information” refers to one or more records retrieved from the internal information storage unit as potential matches to the preference conditions of the user.

The term “suitability score” refers to a numerical or ordinal value computed by the processor to quantify how well a particular candidate information item satisfies the preference conditions of the user.

The term “prompt sentence” refers to a text sequence generated by the processor for input to a generative AI model, the text sequence including at least an instruction content, a summary of candidate information, and potentially information about the user's emotional state or notification tone.

The term “instruction content” refers to directive text contained in the prompt sentence that specifies a task to be performed by the generative AI model, such as selecting a recommended target and generating an explanation.

The term “generative AI model” refers to an information processing model that receives a prompt sentence and generates text output, such as recommendations, explanations, or notification messages, based on learned patterns from data.

The term “generation result” refers to output text produced by the generative AI model in response to a prompt sentence, the output text including at least one recommended target and a reason for recommendation.

The term “structured information” refers to data items stored in the internal information storage unit in a predefined format, such as records in tables with fields corresponding to attributes of recruitment information or allocation target information.

The term “matching result data” refers to information generated by integrating the generation result with structured information, the information being suitable for presentation to the user as an outcome of a matching process.

The term “notification content” refers to text or data prepared for delivery to the user or another recipient, the text or data including at least the matching result data and explanatory or contextual information.

The term “notification tone” refers to stylistic or expressive characteristics of the notification content, such as politeness level, degree of encouragement, or emphasis, which can be adjusted based on the emotional state of the user.

The term “external communication service” refers to a communication platform or messaging service, separate from the server, which can deliver messages to the user or other recipients, such as an email service, a messaging application, or another network-based communication service.

The term “communication interface” refers to a hardware and/or software component that enables the server to exchange data with the user terminal or with an external communication service over a communication network.

In one embodiment, a server provides a computer-implemented matching system that associates a user with recruitment information or allocation targets stored in an internal information storage unit. The server includes at least one processor, a memory, a network interface, and a non-transitory storage medium storing a program. The processor executes the program to perform emotion-aware analysis of user input, to search and rank candidate records in a database, to generate a prompt sentence for a generative AI model, and to integrate the output of the generative AI model with structured internal data to produce matching result data and notification content.

A server uses a database management system, such as a relational database engine, to implement the internal information storage unit. The internal information storage unit stores, in tables, recruitment information (for example, position identifiers, department identifiers, required skills, work location, work schedule attributes, and work style attributes) and allocation target information (for example, site identifiers, required capabilities, shift times, and resource status). A server defines explicit data structures for these tables, such as key-value pairs for attributes and foreign keys for linking positions to departments or sites to regions. This structured storage allows the processor to execute indexed queries and join operations efficiently, thus reducing search latency even when the number of stored records is large.

A terminal presents a user interface implemented, for example, using HyperText Markup Language, style description language, and client-side scripting language. A terminal executes a web browser or a native application that renders input fields for job type, location, schedule preference, skills, and free-text comments. A terminal transmits input information from a user to the server via a network using a transport protocol, for example a hypertext transfer protocol over transport layer security. A user inputs free-text descriptions such as “I want to work in a sales department with a flextime system,” “Data scientist, Tokyo,” or “Skills: night patrol, CCTV operation; preferred: night shifts only,” and selects structured options such as work location and work time categories.

A server receives input information and stores the information in the internal information storage unit together with metadata, such as timestamps, user identifiers, and terminal type. A server applies a text preprocessing module implemented in a programming language, such as a scripting language or a general-purpose language. The text preprocessing module performs tokenization, lowercasing, stop-word removal, and subword segmentation. A server encodes the preprocessed text into numerical feature vectors using either word embeddings, sentence embeddings, or contextual embeddings generated by a text encoder, such as a recurrent neural network or a transformer encoder network. These feature vectors form input features for an emotion classification model and a preference extraction model.

A server implements an emotion classification model as a neural network trained to output a probability distribution over predefined emotional states, such as “stressed,” “highly motivated,” “seeking flexibility,” “neutral,” and “anxious.” In one embodiment, the emotion classification model comprises multiple layers of a neural architecture, for example an embedding layer, one or more self-attention layers, and a fully connected output layer with a softmax function. During training, the server uses a supervised learning procedure on labeled text data, an error function such as cross-entropy loss, and a gradient-based optimization algorithm such as stochastic gradient descent or an adaptive variant to update model parameters. The server optionally applies regularization methods and data augmentation (for example, synonym replacement and paraphrasing) to improve generalization. At runtime, the server executes only the forward inference pass of this model. The emotion classification model outputs a vector of probabilities, and the processor selects the emotional state with the highest probability as the emotional state of the user.

A server implements a preference extraction model to map user text to structured preference conditions. The preference extraction model may also be a neural network, for example a sequence labeling network or a classification network, configured to identify entities such as job category, location, working style, and skill categories. The model outputs structured fields (for example, job_category=“sales,” working_style=“flextime,” location=“urban region A”). The server stores these extracted preference conditions in the internal information storage unit for subsequent matching.

A server then performs candidate search using structured queries. A server constructs query expressions over the database tables based on the preference conditions. For example, the server may perform a search for recruitment information records where a job category field matches a user's job category, a location field is within a user-selected region, and a work style field matches a user's desired work style. For allocation targets in fields such as security staffing, the server may search for sites where capability requirements intersect with the user's skill set, and shift times match the user's time preferences. Because the server uses indexed columns and appropriate query plans, the server reduces input/output operations and accelerates candidate retrieval, thereby improving the performance of the matching process.

A server calculates a suitability score for each candidate record using a scoring function. The scoring function may be implemented as a rule-based function or as a learned model. In a rule-based variant, the server defines weighted contributions for different attribute matches, such as an exact location match, skill overlap, work style compatibility, and schedule overlap. The server applies numerical weights, for example increasing the weight of flexible work attributes when the emotional state indicates “seeking flexibility,” or increasing the weight of high-responsibility roles when the emotional state indicates “highly motivated.” In a learned variant, the server uses a neural network that takes as input numerical encodings of the candidate attributes and the user features, and outputs a compatibility score. In both cases, the server ranks candidates by descending suitability score and selects a subset of highly ranked candidates as candidate information for further processing.

A server generates a prompt sentence in natural language for a generative AI model. A server builds the prompt sentence by combining segments: (i) an instruction content that tells the generative AI model what operation to perform, (ii) a summary of the ranked candidate information, and (iii) an indication of the emotional state and desired notification tone. A server formats the prompt sentence as a sequence of sentences or bullet-style descriptions, explicitly including candidate identifiers, attribute summaries, and the emotional state. The server uses deterministic rules to ensure that the prompt sentence respects a token-length constraint and presents essential attributes first. By generating the prompt sentence in this structured manner, the server minimizes ambiguity for the generative AI model and reduces the need for additional clarification calls, thus saving network bandwidth and processor time. In one example, the server generates a prompt sentence as follows:

“The user wrote: ‘I want to work in a sales department with a flextime system.’

The user's emotional state is: seeking flexibility and better work-life balance.

The following internal job postings are available:
1) Inside Sales Team B: flextime=true, remote=true, location=Region X.
2) Field Sales Team A: flextime=partial, remote=false, location=Region X.
3) Support Sales Team C: flextime=true, remote=false, location=Region Y.

Using this information, select the single best department for the user and explain briefly why it fits. Answer in concise business English.”

In another example, the server generates a prompt sentence as follows:

“A security staff member has skills ‘night patrol’ and ‘CCTV operation’ and prefers night shifts only.

The user's emotional state indicates high motivation for stable night work.

Available sites are:
Site 1: requires night patrol and CCTV operation, night only.
Site 2: requires day patrol only.
Site 3: requires mixed day/night rotation.

Choose the best site for this staff member and justify your choice in 2-3 sentences.”

A server transmits the prompt sentence to a generative AI model via an application programming interface. The generative AI model may be implemented as a large-scale language model, such as a transformer-based neural network trained on text corpora. The generative AI model receives the prompt sentence as input and outputs generated text. The server controls parameters such as temperature, maximum token length, and top-k sampling to ensure deterministic or near-deterministic behavior as appropriate. Because the server provides a structured prompt sentence containing ranked candidate information and explicit instructions, the generative AI model can generate concise, targeted recommendation text with a reduced error rate and improved relevance compared to generic prompts.

A server receives a generation result from the generative AI model, including at least one recommended target and one or more reasons for recommendation. The server parses the generated text to identify a recommended target name or identifier and an explanation portion. The server may use rule-based parsing, pattern matching, or a lightweight text classifier to distinguish between identifiers and description sentences. The server then associates the parsed recommended target with a specific record in the internal information storage unit by matching identifiers or unique attributes, thereby ensuring that the generative output is grounded in existing structured data.

A server integrates the structured record and the generation result into matching result data. The matching result data may include fields for a position identifier, a department identifier, a site identifier, a computed suitability score, key attributes (such as location and work style), and a textual explanation. The server stores the matching result data in the internal information storage unit and generates notification content based on the matching result data. The notification content is tailored to the emotional state of the user, for example by using more reassuring wording when the emotional state is “stressed,” or by emphasizing challenges and growth opportunities when the emotional state is “highly motivated.”

A server generates notification content as a sequence of sentences or as a formatted message. For example, for a user seeking flexibility and identified as stressed, the server may generate: “We have found a position that supports your need for flexible working: Inside Sales Team B in Region X. This team offers full flextime and supports remote work, which can help you maintain a comfortable work-life balance.”

For a security staff member with high motivation for night work, the server may generate: “A night security assignment that matches your skills in night patrol and CCTV operation is available at Site 1. This assignment provides stable night shifts in line with your preferences.” A server transmits the notification content and matching result data to a terminal via the network interface. A terminal receives the notification content and displays the information on a display device. A user can then view the recommended target, read the explanation, and, in some implementations, select options such as confirming interest, requesting alternatives, or adjusting preferences. A terminal transmits such responses back to the server, and the server iteratively refines the matching process.

A server may also use an external communication service to deliver notification content. A server constructs a message payload containing a subset of the matching result data and the notification content, and sends this payload via a communication interface to an electronic mail service, a messaging platform, or another external communication service. This unified approach to message construction and delivery reduces duplication of logic for different communication channels and enables centralized control of message formatting, thereby lowering maintenance overhead and improving consistency across services.

This system yields technical effects beyond mere automation of human decision-making. By performing emotion-aware feature extraction, structured candidate scoring, and explicit prompt sentence generation for a generative AI model, the server reduces the number of iterative queries, decreases processing time for each user session, and improves matching accuracy. The use of optimized database queries and ranking functions reduces computational complexity for search operations, which leads to shorter response times even when operating on large datasets. The hierarchical combination of neural models (emotion classification and preference extraction) with deterministic scoring logic and generative AI interaction improves the quality and consistency of output compared with conventional rule-only or template-only systems.

The system also uses computer-specific techniques to manage network and computation resources. For example, by limiting the number of candidates included in the prompt sentence and by compressing attribute summaries, the server reduces the length of payloads sent to the generative AI model, thereby reducing bandwidth consumption and inference latency. By caching intermediate embeddings or precomputed suitability scores for frequently occurring preference patterns, the server can reuse computation across users, further increasing throughput.

A server can employ alternative embodiments. In one embodiment, the server implements the emotion classification model as a convolutional neural network rather than a transformer, using n-gram features derived from tokenized text. In another embodiment, the server uses a gradient-boosted decision tree model to compute suitability scores, trained on historical matching outcomes. In yet another embodiment, the server generates multiple prompt sentences with different candidate subsets and merges the generation results to improve robustness. The underlying architecture namely, the extraction of emotional state and preferences, the search in an internal information storage unit, the ranking of candidate information, the generation of an explicit prompt sentence for a generative AI model, and the integration of generated recommendations with structured records remains common across these embodiments.

A terminal may be implemented as a smart phone, a tablet, a desktop computer, or a wearable device such as smart glasses. In a retail or service scenario, the terminal operated by staff receives notifications that instruct staff how to respond to a customer. For example, if a user wearing a device inputs “I am looking for a relaxing cafe space,” a server determines that the emotional state is “seeking relaxation,” searches a location database for a quiet area, generates a prompt sentence for a generative AI model such as:

“The user is looking for a relaxing cafe space and wants a calm atmosphere. Available areas are: Area A (quiet, soft music), Area B (crowded, loud background), Area C (outdoor, moderate noise). Select the best area and generate a short instruction for staff on how to guide the user.”

The generative AI model outputs a recommended area and guidance text, and the server generates notification content such as:
“Guide the user to Area A with softer lighting and quieter background sound, and suggest a non-caffeinated drink.”

In this way, the server not only provides matching results but also produces device-level instructions that directly influence real-world guidance behavior. This tight integration between emotion-aware data processing, generative text generation, and terminal display contributes to an improvement in the functioning of the overall computer system by reducing the need for manual interpretation and increasing the precision and speed of responses.

Because the server systematically encodes emotional state and candidate structure into prompt sentences, controls generative model invocation, and integrates outputs with database records, the system provides a non-conventional and non-generic arrangement of computing components. The described architecture and data flows result in improved matching precision, faster computation, and reduced communication overhead, thereby improving computer technology itself rather than merely implementing a business practice on a generic computer.

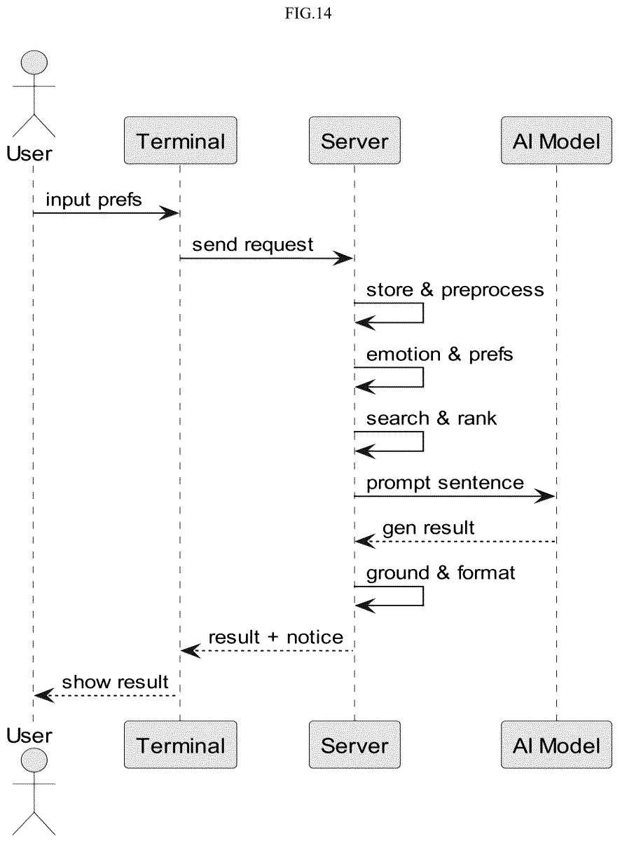

The following describes the processing flow using FIG. 14.

### Step 1:

User inputs initial information through the terminal.
User enters free-text content (for example, “I want to work in a sales department with a flextime system.”, “Data scientist, Tokyo.”, or “Skills: night patrol, CCTV operation; preferred: night shifts only.”) and selects structured options such as location and available time slots on a user interface displayed by the terminal.
Terminal sends an HTTP request to the server including the raw text, selected options, a user identifier, and terminal metadata as input. Terminal does not modify semantic content; terminal only packages the input as structured data (for example, JSON fields) and transmits it over a network. The output of Step 1 is a network message containing the user's text and structured selections delivered to the server.

### Step 2:

Server receives and stores the raw input.
Server accepts the HTTP request via a network interface and a web framework, and extracts input fields such as text content, job type selection, location selection, and time preferences as input.
Server performs basic validation (for example, checking non-empty values and allowed value ranges) and normalizes the text (lowercasing, trimming whitespace, removing control characters).
Server writes the normalized text, structured selections, user identifier, and timestamp into tables of an internal database as a new request record.
The data processing in this step is conversion of network-layer payload into persistent structured records.
The output of Step 2 is a stored request record identified by a request ID in the internal information storage unit.

### Step 3:

Server preprocesses the text and extracts feature representations.
Server reads the stored request record (input) from the database using the request ID.
Server applies a text preprocessing pipeline: tokenizing the text into tokens, removing stop-words, performing subword segmentation if needed, and mapping tokens to integer indices based on a vocabulary.
Server passes the token indices through an embedding module (for example, an embedding matrix followed by positional encoding), thereby converting discrete tokens into dense numerical vectors.
Server outputs a sequence vector representation and, if needed, a pooled vector representation (for example, average or special-token representation).
The main data operation is mapping raw text to numerical feature vectors suitable for neural network inference.
The output of Step 3 is a feature vector set representing the user's text.

### Step 4:

Server determines the user's emotional state using an emotion classification model.
Server uses the feature vector set from Step 3 as input to an emotion classification neural network stored in memory.
Server performs a forward pass through multiple layers (for example, self-attention layers and fully connected layers) to compute a probability distribution over predefined emotional classes.
Server selects the emotional class with the maximum probability and obtains an associated confidence score.
Server writes the emotional state label and score back into the request record in the database. The data operation is classification: transforming feature vectors into a probability vector and then into a discrete emotional label.
The output of Step 4 is an emotional state of the user associated with the request ID.

### Step 5:

Server extracts structured preference conditions from the input.
Server uses the same or additional feature vectors derived from the user's text and the structured selections as input to a preference extraction model or rule set.
Server applies either a sequence labeling model or rule-based pattern matching to identify entities such as job category, location, work style, skills, and schedule preference.
Server converts identified entities into structured fields (for example, job_category=“sales”, work_style=“flextime”, location_region=“Region X”, skills={“night patrol”, “CCTV operation”}).
Server writes these structured preference conditions into the database, linked to the request ID.
The data processing is entity extraction and normalization: converting unstructured text and selections into discrete attribute values.
The output of Step 5 is a structured preference profile for the user.

### Step 6:

Server searches for candidate records in the internal information storage unit.
Server uses the structured preference profile and the emotional state as input to construct database queries over recruitment information and allocation target information tables.
Server executes a set of search operations, for example: filtering by job_category, filtering by location_region, filtering by work_style, and intersecting required skills with user skills.
Server uses indexed columns and joins to limit the candidate set and to avoid full table scans, thus reducing I/O overhead.
Server retrieves matching rows as candidate information records containing IDs, attribute fields, and status (for example, open/closed).
The data operation is a constrained search over structured records using query conditions derived from preference conditions.
The output of Step 6 is a list of candidate information records.

### Step 7:

Server computes suitability scores and ranks the candidates.
Server takes as input the list of candidate information records and the preference profile, and optionally the emotional state.
Server encodes candidate attributes (for example, location, work_style, skills, shift times) into numerical feature vectors, and encodes user preferences into a companion vector.
Server applies a scoring function: either a rule-based weighted sum (for example, +w1 for exact location match, +w2 for complete skill match, +w3 for work_style match) where weights are adjusted according to emotional state, or a learned scoring model such as a neural network or gradient-boosted decision tree.
Server calculates a suitability score for each candidate and sorts the candidate list in descending order of suitability.
Server truncates the list to a top-N subset to limit subsequent processing and communication.
The data processing is ranking: mapping candidate attributes and user features to scalar scores and generating an ordered list.
The output of Step 7 is a ranked candidate list with associated suitability scores.

### Step 8:

Server composes a prompt sentence for a generative AI model.
Server uses as input the emotional state, the preference profile, and the top-N ranked candidate list.
Server selects key attributes from each candidate (for example, department name, location, work_style, key skills) and formats them into short bullet-style or sentence-style descriptions.
Server generates an instruction segment that describes the task for the generative AI model (for example, “select the single best department and explain briefly why it fits”).
Server appends emotional state information and desired notification tone (for example, “seeking flexibility and better work-life balance; use a reassuring tone”).
Server concatenates the instruction segment, emotional state description, and candidate summaries into a single textual prompt sentence.
The data operation is structured text generation: converting structured data and labels into a controlled natural-language sequence.
The output of Step 8 is a prompt sentence ready to be sent to a generative AI model.

### Step 9:

Server sends the prompt sentence to a generative AI model and receives a generation result.
Server transmits the prompt sentence and configuration parameters (for example, temperature, maximum tokens) as input to a generative AI model via an API call over a network.
Server waits for a response and receives generated text, which typically contains a recommended target (for example, one candidate department or site) and an explanation.
Server logs the prompt and response pair to persistent storage for traceability and future optimization.
The data processing is external model invocation and response acquisition: encapsulating the prompt as a request and decoding the response as plain text.
The output of Step 9 is a generation result containing at least one recommended candidate and explanatory text.

### Step 10:

Server parses and grounds the generation result in structured data.
Server takes the generation result text as input and applies parsing rules or a simple classifier to identify candidate names, identifiers, or descriptions that match known candidate records.
Server maps the identified recommended target to a specific candidate record by checking identifiers or matching attributes against the ranked candidate list.
Server isolates the explanatory portion of the generation result and stores it as a text field associated with the recommended candidate.
Server discards or flags any portion of the text that does not correspond to existing internal records, thus ensuring that the final output is consistent with the database state.
The data operation is entity grounding: aligning natural-language output with structured records.
The output of Step 10 is a grounded recommendation consisting of a candidate record identifier and associated explanation.

### Step 11:

Server generates matching result data and notification content.
Server uses as input the grounded recommendation, the original ranked candidate list, the emotional state, and the preference profile.
Server constructs matching result data including the recommended candidate's ID, title, location, work_style, key attributes, and computed suitability score, along with the explanation from the generative AI model.
Server then generates notification content as user-facing text, selecting wording and emphasis based on the emotional state (for example, emphasizing flexibility for “seeking flexibility,” or emphasizing challenge for “highly motivated”).
Server may include a short summary of alternatives (for example, “You may also consider Department Y and Department Z”) using data from the ranked candidate list.
The data processing is aggregation and text formatting: combining structured fields and explanatory text into a coherent message.
The output of Step 11 is structured matching result data and corresponding notification content.

### Step 12:

Server delivers the notification content and matching result data to the terminal and/or an external communication service.
Server takes as input the notification content and matching result data and selects delivery channels based on configuration (for example, direct terminal response, email, or messaging platform).
Server formats payloads appropriate to each channel (for example, HTML for email, plain text or rich text for messaging platforms) while preserving core content.
Server transmits the payload to the terminal via an HTTP response or to external services via corresponding APIs.
Terminal receives the response and displays the notification content and key fields from the matching result data to the user.
The data processing is channel-specific packaging and transmission: converting internal representations into channel-specific message formats.
The output of Step 12 is a displayed recommendation and explanation on the terminal and, where configured, delivered messages in external communication applications.

### Step 13:

User reviews the recommendation and optionally provides feedback or updated preferences.
User reads the notification content displayed on the terminal and inspects details such as job title, work_style, location, and explanation.
User may select actions such as “accept”, “apply”, “request alternatives”, or “change preferences”.
Terminal packages the selected action or new preference values as input and transmits them back to the server in a new request, referencing the prior request ID if needed.
The data processing at this step is user-driven: converting human selections into machine-readable feedback and new input information.
The output of Step 13 is updated input information that can trigger a new execution of Steps 2 onward, enabling iterative refinement of the matching process.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

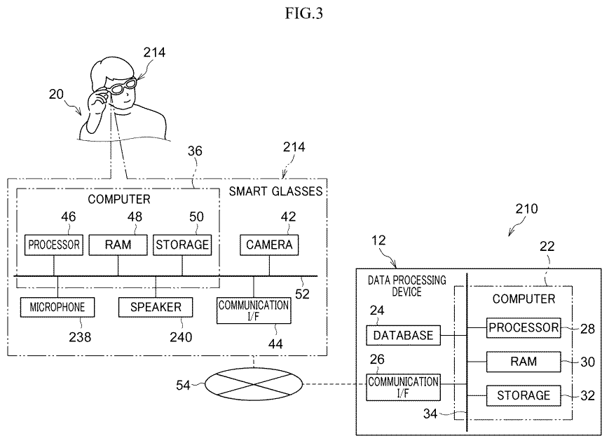

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

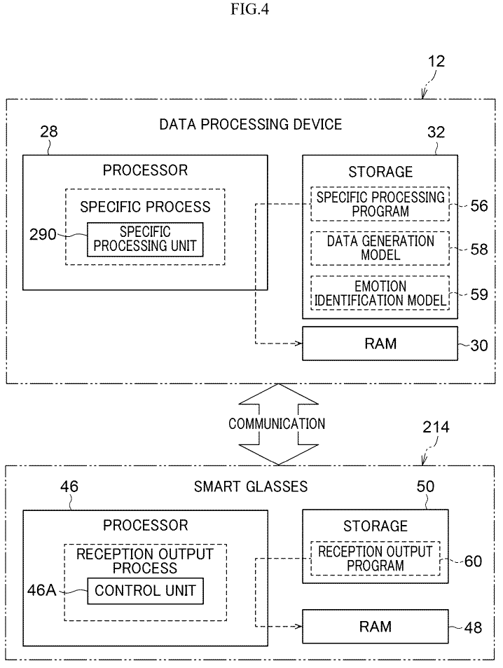

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

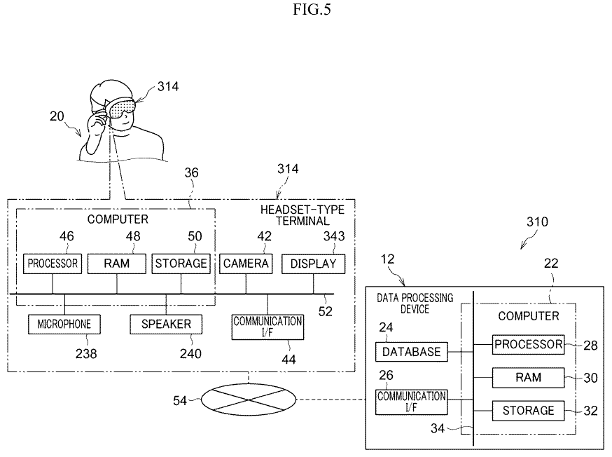

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

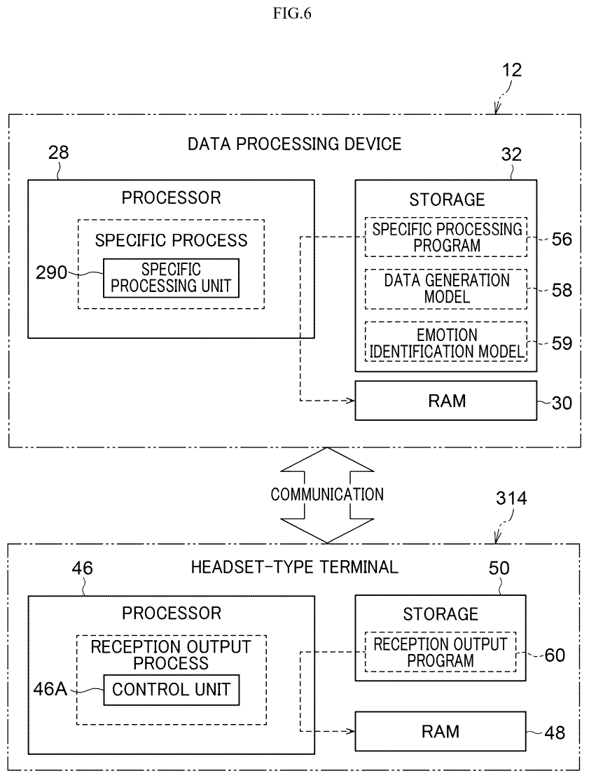

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

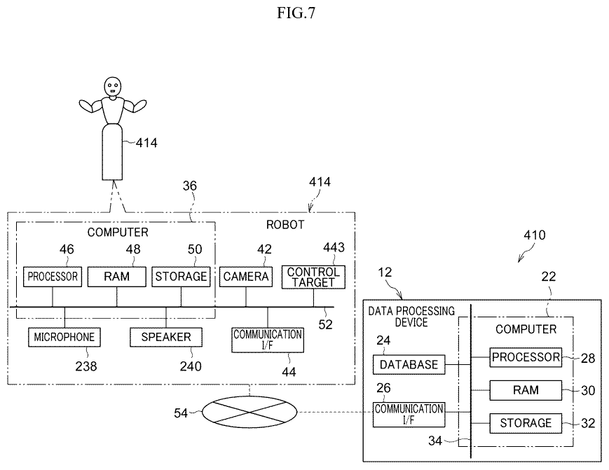

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

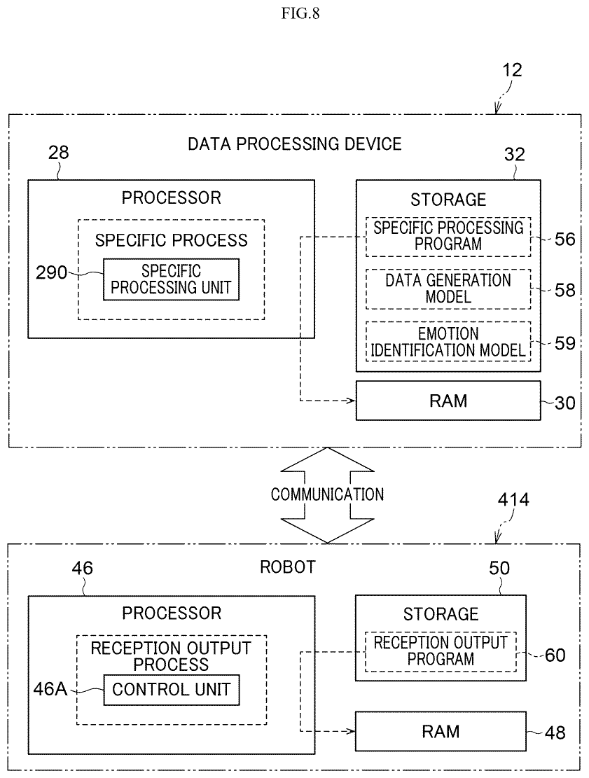

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

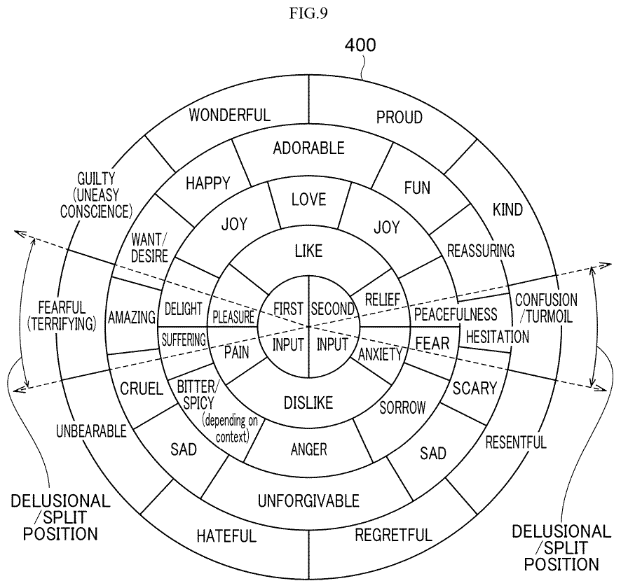

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

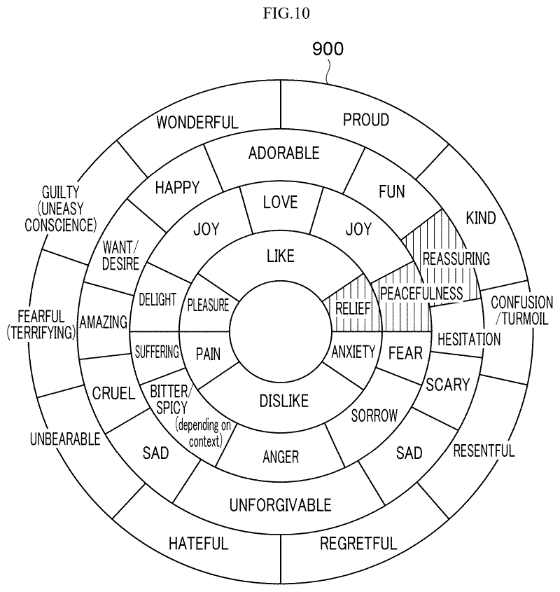

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal device, input information concerning working conditions and job contents provided by a user,
analyze the input information to recognize an emotional state of the user and to convert the input information into structured data as attribute information,
generate, on the basis of the structured data and the emotional state, a prompt sentence in natural language including at least one condition selected from a work category, a working style, a work location, an overtime work condition, and an experience period, and prepare the prompt sentence for input to a generative AI model,
input the prompt sentence to the generative AI model and obtain, as generated text, recruitment information and explanatory information relating to candidate assignment departments,
analyze the generated text to extract, for each candidate recruitment department, items including an affiliation category, a working system, a remote work condition, and an overtime work condition, and compare the extracted items with the structured data to calculate an evaluation value indicating a degree of matching for each candidate,
determine a correspondence relationship between the user and a recruitment department on the basis of the evaluation value and convert a result of the determination into presentation information in a data format for presentation to the user, and
transmit the presentation information to the terminal device via a communication line so that the user can view the presentation information on the terminal device.

### (Supplementary 2)

The system according to supplementary 1,
wherein the processor is configured to cooperate with an external communication application to transmit the presentation information.

### (Supplementary 3)

The system according to supplementary 1,
wherein the processor is configured to adjust an expression of the prompt sentence and an expression of the presentation information on the basis of the emotional state of the user.

### Application Example 1

### (Supplementary 1)

A system comprising a processor,
wherein the processor is configured to receive input information from a user including conditions related to an item, and analyze the input information to extract requirement attributes of the user,
search an information storage device that stores item information corresponding to the requirement attributes, and generate a prompt sentence for generation by formatting, as natural-language description information, the requirement attributes based on a search result, input the prompt sentence for generation into a generative AI model, and obtain a plurality of item candidate information that conforms to the requirement attributes of the user by text generation processing of the generative AI model,
analyze text of the item candidate information, convert the text into structured data including an item name, an item description, price information, and a suitability reason, and filter and rank the item candidate information based on a degree of conformity to the requirement attributes to specify recommended item information to be presented to the user,
convert the recommended item information into a display data format, transmit the display data format to a user terminal, and cause the user terminal to visually present the recommended item information, and
record the prompt sentence for generation, response text from the generative AI model, and the recommended item information as history information, and update a template of the prompt sentence for generation or conditions of the ranking based on the history information.

### (Supplementary 2)

The system according to supplementary 1,
wherein the processor is configured to
generate a notification message including a summary content of the recommended item information and identification information that enables reference to the recommended item information, and transmit the notification message to the user in real time in cooperation with an external communication application.

### (Supplementary 3)

The system according to supplementary 1,
wherein the processor is configured to adjust a writing style, a level of detail, or a number of item candidates to be presented in the notification message based on the input information obtained from the user or the history information.

### Example 2

### (Supplementary 1)

A system comprising a processor,
wherein the processor is configured to
receive input information from a user,
analyze the input information and recognize an emotional state of the user,
generate a prompt sentence including natural language on the basis of the input information and an analysis result regarding the emotional state,
input the prompt sentence to a generative AI model and obtain, from the generative AI model, structured condition information representing desired conditions of the user,
generate a query expression using the structured condition information and input the query expression to a database search engine to search recruitment information,
generate a matching result between the user and a recruitment entity on the basis of the recruitment information obtained by the search, and
convert the matching result into output information and notify the matching result to a user terminal via communication processing.

### (Supplementary 2)

The system according to supplementary 1,
wherein the processor is configured to cooperate with an external communication application to transmit the matching result to the user terminal and cause the user terminal to generate a search result display screen including the recruitment information.

### (Supplementary 3)

The system according to supplementary 1,
wherein the processor is configured to dynamically adjust the prompt sentence and notification content of the matching result on the basis of the analysis result regarding the emotional state of the user and the structured condition information obtained from the generative AI model.

### Application Example 2

### (Supplementary 1)

A system comprising a processor,
wherein the processor is configured to
receive input information from a user terminal,
analyze the received input information to extract an emotional state of the user and preference conditions of the user,
search, on the basis of the extracted emotional state and the extracted preference conditions, recruitment information or allocation target information stored in an internal information storage unit to obtain candidate information,
compare the candidate information with the preference conditions of the user and calculate suitability scores for respective candidates and rank the candidates based on the suitability scores,
generate a prompt sentence including an instruction content for a generative AI model, a summary of the ranked candidate information, and a notification tone, based on the emotional state and the ranked candidate information,
input the generated prompt sentence into the generative AI model and obtain a generation result including at least one recommended target among the candidates and a reason for recommendation,
associate and integrate the generation result with structured information stored in the internal information storage unit to generate matching result data to be presented to the user,
generate notification content based on the matching result data and adjust an expression of the notification content according to the emotional state of the user, and transmit the adjusted notification content and the matching result data to the user terminal for display.

### (Supplementary 2)

The System According to Supplementary 1,
wherein the processor is configured to include, in the prompt sentence, the emotional state of the user, the preference conditions of the user, and a list of the candidate information, and to obtain, from the generative AI model, explanation text for the user and recommendation content at the same time, and to present the explanation text and the recommendation content to the user as at least part of the matching result data.

### (Supplementary 3)

The system according to supplementary 1,
wherein the processor is configured to generate a message exchange request via a communication interface for cooperation with an external communication service, and to transmit, to the external communication service, a message including the notification content generated by the generative AI model, thereby notifying the user of the matching result.

What is claimed is:

1. A system comprising:
circuitry configured to:
receive, via a communication interface coupled to a packet-switched network, input data from a terminal device, tokenize a prompt sentence incorporating the input data and an instruction for a generative neural network model to extract competency features and emotional state indicators, transmit the tokenized prompt sentence to an inference engine executing the generative neural network model, and decode an output token sequence from the inference engine to obtain a structured feature set comprising a state classification and preference parameters;
execute a search process on an attribute record data store using the preference parameters to retrieve a subject record set, compute a suitability score for each subject record by comparing fields of the subject attribute record against the preference parameters, and rank the subject records by suitability score to generate ranked subject data; and
generate a second prompt sentence encoding the state classification, the ranked subject data, and output tone instructions, transmit the second prompt sentence to the inference engine, decode an output token sequence to obtain a result set comprising at least one matched record and a rationale, integrate the result set with structured attribute records from the attribute record data store to generate matching result data, adjust a presentation format of the matching result data based on the state classification, and transmit the adjusted matching result data to the terminal device via the communication interface.

2. The system according to claim 1, wherein the circuitry is configured to apply subword segmentation to the prompt sentence prior to tokenization, encode the segmented prompt sentence using a vocabulary index of the generative neural network model stored in a storage device, and configure inference parameters including temperature and maximum output length prior to transmission to the inference engine.

3. The system according to claim 2, wherein the circuitry is configured to parse the structured feature set decoded from the inference engine to extract a state category label and a plurality of preference parameter fields, and store the structured feature set in the storage device in association with a session identifier.

4. The system according to claim 3, wherein the input data comprises at least one of text input data, voice input data, and selection input data, and wherein the state category label represents at least one of an anxiety level, a motivation level, a stress level, and an interpersonal expectation level derived from the input data.

5. The system according to claim 1, wherein the circuitry is configured to generate a query expression using the preference parameters, transmit the query expression to a search engine coupled to the attribute record data store to retrieve subject attribute records, and filter the retrieved subject attribute records based on at least one constraint parameter derived from the preference parameters.

6. The system according to claim 5, wherein the circuitry is configured to compute the suitability score as a weighted sum of individual dimension scores, each dimension score reflecting a degree of match between a field of the subject attribute record and a corresponding preference parameter, and determine weighting coefficients based on priority indicators extracted from the structured feature set.

7. The system according to claim 6, wherein the circuitry is configured to construct the second prompt sentence by encoding the state classification as a labeled tone section, the ranked subject data as a labeled subject summary section, and output format instructions as a labeled constraint section.

8. The system according to claim 7, wherein the circuitry is configured to parse the result set decoded from the inference engine to extract a matched record identifier and an associated rationale string, and store the matched record identifier and the rationale string in the storage device as part of the matching result data.

9. The system according to claim 1, wherein the circuitry is configured to receive response data from the terminal device via the communication interface indicating a user action taken in response to the matching result data, store the response data in the storage device in association with the session identifier, and update the preference parameters based on the response data.

10. The system according to claim 9, wherein the circuitry is configured to update weighting coefficients stored in the storage device based on the response data, and apply the updated weighting coefficients in subsequent subject record ranking operations to improve alignment between ranked subject data and user preferences.

11. The system according to claim 1, wherein the circuitry is configured to generate a follow-up prompt sentence encoding the state classification and the matching result data, transmit the follow-up prompt sentence to the inference engine, decode an output token sequence to obtain follow-up guidance data, and transmit the follow-up guidance data to the terminal device via the communication interface.

12. The system according to claim 11, wherein the circuitry is configured to adjust a content and a level of detail of the follow-up guidance data based on the state classification, and to store the follow-up guidance data in the storage device in association with the session identifier.

13. The system according to claim 1, wherein the circuitry is configured to retrieve historical session records from the storage device, extract trend data reflecting changes in the state classification across sessions, and incorporate the trend data into the prompt sentence as an additional labeled context section prior to tokenization.

14. The system according to claim 13, wherein the circuitry is configured to generate a longitudinal summary prompt sentence encoding the trend data and the matching result data, transmit the longitudinal summary prompt sentence to the inference engine, decode an output token sequence to obtain progress narrative data, and transmit the progress narrative data to the terminal device.

15. The system according to claim 1, wherein the circuitry is configured to recompute suitability scores for subject records in the attribute record data store using updated weighting coefficients, regenerate the ranked subject data, and retransmit an updated second prompt sentence to the inference engine to obtain an updated result set reflecting the recomputed suitability scores.

16. The system according to claim 15, wherein the circuitry is configured to transmit updated matching result data to the terminal device via the communication interface, the updated matching result data reflecting the updated result set and adjusted according to a current state classification re-extracted from subsequently received input data.

17. The system according to claim 1, wherein the circuitry is configured to store the tokenized prompt sentence, the structured feature set, the ranked subject data, and the matching result data as a session record in the storage device indexed by the session identifier, and retrieve prior session records when generating subsequent prompt sentences to condition the inference engine on prior interaction history.

18. A system comprising:
circuitry configured to:
receive, via a communication interface coupled to a packet-switched network, input data from a terminal device, tokenize a prompt sentence incorporating the input data, transmit the tokenized prompt sentence to an inference engine executing a generative neural network model, and decode an output token sequence to obtain a structured feature set comprising a state classification and preference parameters;
execute a search process on an attribute record data store using the preference parameters to retrieve a subject record set, compute suitability scores by comparing subject attribute record fields against the preference parameters, and rank the subject records by suitability score to generate ranked subject data;
generate a second prompt sentence encoding the state classification, the ranked subject data, and output tone instructions, transmit the second prompt sentence to the inference engine, and decode an output token sequence to obtain a result set comprising a matched record identifier and a rationale; and
integrate the result set with structured attribute records to generate matching result data, adjust a presentation format based on the state classification, and transmit the adjusted matching result data to the terminal device via the communication interface.

19. The system according to claim 18, wherein the circuitry is configured to receive response data from the terminal device indicating a user action in response to the matching result data, update the preference parameters and weighting coefficients stored in a storage device based on the response data, and apply the updated weighting coefficients in subsequent subject record ranking operations.

20. A method comprising:
receiving, via a communication interface coupled to a packet-switched network, input data from a terminal device, tokenizing a prompt sentence incorporating the input data and an instruction for a generative neural network model to extract competency features and emotional state indicators, transmitting the tokenized prompt sentence to an inference engine executing the generative neural network model, and decoding an output token sequence from the inference engine to obtain a structured feature set comprising a state classification and preference parameters;
executing a search process on an attribute record data store using the preference parameters to retrieve a subject record set, computing a suitability score for each subject record by comparing fields of the subject attribute record against the preference parameters, and ranking the subject records by suitability score to generate ranked subject data; and
generating a second prompt sentence encoding the state classification, the ranked subject data, and output tone instructions, transmitting the second prompt sentence to the inference engine, decoding an output token sequence to obtain a result set comprising at least one matched record and a rationale, integrating the result set with structured attribute records to generate matching result data, adjusting a presentation format of the matching result data based on the state classification, and transmitting the adjusted matching result data to the terminal device via the communication interface.
